(19) United States
(12) Patent Application Publication
(10) Pub. No.: US 2018/0087443 A1
(43) Pub. Date: Mar. 29, 2018

(54) ADDITIVE MANUFACTURED COMBUSTION ENGINE

(71) Applicant: Additive Rocket Corporation, Oceanside, CA (US)

(72) Inventors: Kyle Adriany, San Diego, CA (US); Andy Kieatiwong, San Diego, CA (US); Anthony Tran Tran, Monterey Park, CA (US); Elyce Bayat Bayat, Pleasanton, CA (US); Michael Knight, Oceanside, CA (US); Nicholas Lopez, Anaheim, CA (US); Nicholas Garrett, Victorville, CA (US); Ryan Pedersen, Walnut, CA (US)

(21) Appl. No.: 15/694,686

(22) Filed: Sep. 1, 2017

Related U.S. Application Data
(60) Provisional application No. 62/385,123, filed on Sep. 8, 2016.
(60) Provisional application No. 62/382,722, filed on Sep. 1, 2016.
(60) Provisional application No. 62/385,122, filed on Sep. 8, 2016.

(51) Int. Cl. F01P 11/04; F01P 3/20

(52) U.S. Cl. CPC F01P 11/04; F02M 53/043; F01P 3/20

(57) ABSTRACT

Aspects of the present disclosure are presented for a combustion engine design with an optimized amount of materials used to generate the necessary components of the engine. The engine may be generated as a single piece, having no joints, fasteners, or any other areas that could present a risk for damage. The designs are described may also reduce weight of the engine, due to eliminating the need for fasteners and other extraneous hardware. In general, the weight of the engine may be optimized to also preclude the inclusion of extraneous material around needed structures. Also, the engine may be designed to be highly energy efficient, with optimal flows for fuel and other fluid with minimal head loss while maintaining higher pressures.

### CROSS REFERENCES TO RELATED APPLICATIONS

This application claims the benefits of U.S. Provisional Application 62/382,722, filed Sep. 1, 2016, and titled “STRUCTURAL HEAT EXCHANGER”; U.S. Provisional Application 62/385,122, filed Sep. 8, 2016, and titled “FRACTAL FLUID PASSAGES APPARATUS;” and U.S. Provisional Application 62/385,123, filed Sep. 8, 2016, and titled “ADDITIVE MANUFACTURED COMBUSTION ENGINE,” the disclosures of which are incorporated herein by reference in their entireties and for all purposes.

### TECHNICAL FIELD

The subject matter disclosed herein generally relates to coolant systems. More specifically, the present disclosures relate to a structural heat exchanger with various industrial applicabilities.

### BACKGROUND

Conventionally, coolant systems for industrial applications, like in thrust chambers, are manufactured using subtractive manufacturing methods, meaning that larger materials are used which are whittled down until a desired structure is created. These designs are therefore limited by the manufacturing methods employed. In addition, coolant systems are conventionally built with multiple pieces, needing to be welded and fastened together. For ease of manufacturing and replicability, these designs therefore exhibit numerous failure points or other high stress areas. In addition, due to utilizing more reliable subtractive manufacturing methods, optimal geometries for heat transfer, cooling, and propulsion designs are not used. It is desirable therefore to develop new ways of generating heat exchanging coolant systems and their various components.

### BRIEF SUMMARY

Aspects of the present disclosure are presented for a combustion engine design with an optimized amount of materials used to generate the necessary components of the engine.

In some embodiments, a combustion engine is presented including: a heat exchanger comprising a plurality of coolant channels, the heat exchanger configured to divert heat through a wall at least partially enclosing a region containing a high heat volume relative to surrounding volumes; a fluid diverter coupled to the plurality of channels in the heat exchanger; and a fractal fluid passages oxidizer; wherein the combustion engine is manufactured using additive manufacturing.

In some embodiments of the combustion engine, each of the plurality of coolant channels has at least a portion of cross-sectional area in a shape of a bean.

In some embodiments of the combustion engine, each of the plurality of coolant channels has at least a portion of cross-sectional area in a shape of a trapezoid with rounded corners.

In some embodiments of the combustion engine, each of the plurality of coolant channels has at least a portion of cross-sectional area in a shape defined by satisfying a plurality of boundary conditions defining one or more functional or structural properties of the wall.

In some embodiments of the combustion engine, the plurality of boundary conditions include: at least one thermal condition that the wall must satisfy; at least one structural condition that the wall must satisfy; at least one material property about the wall that the wall must satisfy; and at least one material property of the coolant channels that the plurality of coolant channels must satisfy. In some embodiments of the combustion engine, the plurality of boundary conditions is a first plurality of boundary conditions applied to a first location of the coolant channels, and each of the plurality of coolant channels has at least a portion of cross-sectional area at a second location in a second shape defined by satisfying a second plurality of boundary conditions that are different than the first plurality of boundary conditions.

In some embodiments of the combustion engine, the plurality of coolant channels vary in pitch angle at different locations within the wall.

In some embodiments of the combustion engine, at least one of the plurality of coolant channels includes a first cross-sectional area at a first location shaped in a first shape, and a second cross-sectional area at a second location shaped in a second shape. In some embodiments, the first shape is a bean shape, and the second shape is an ellipse shape.

In some embodiments of the combustion engine, the plurality of coolant channels vary in size of cross-sectional area at different locations within the wall.

In some embodiments, the combustion engine further includes an engine flange having threads that are additively manufactured as a single piece along with the engine flange.

In some embodiments of the combustion engine, exterior material of the combustion engine is minimized using a shrink-wrapping additive manufacturing process.

In some embodiments of the combustion engine, the fluid diverter comprises a uniformly decreasing radius annulus.

In some embodiments of the combustion engine, the fractal fluid passages oxidizer comprises smooth branching passages.

In some embodiments of the combustion engine, the fractal fluid passages oxidizer comprises a first portion and second portion of fluid orifices to allow fluid to exit the oxidizer, wherein the first portion of the orifices allow the fluid to exit the oxidizer at a different angle compared to the second portion of the orifices.

In some embodiments, the combustion engine further includes a fractal fluid passages fuel injector. In some embodiments of the combustion engine, the fractal fluid passages fuel injector comprises smooth branching passages.

In some embodiments of the combustion engine, the engine is manufactured as a single piece using additive manufacturing.

### BRIEF DESCRIPTION OF THE DRAWINGS

Some embodiments are illustrated by way of example and not limitation in the figures of the accompanying drawings.

FIG. 1 is an illustration of an example engine utilizing a structural heat exchanger according to the present disclosures.

FIGS. 2-7 and related descriptions provide descriptions of traditional coolant systems that serve as a point of comparison to highlight the novel and nonobvious features of the present disclosures.

FIG. 8 shows a fuel diverter have a uniform annular radius.

FIG. 9 shows a fuel diverter in the shape of a decreasing radius annulus, according to some embodiments.

FIG. 10 shows an illustration of fluid being delivered through each channel out of the fluid diverter.

FIG. 11 shows an illustration of a flow vector simulation of the direction and magnitude of the liquid as it enters the offshoot passages from the fluid diverter, according to some embodiments.

FIG. 12 shows a semi-transparent view of the bottom of an engine utilizing a heat exchanger of the present disclosures.

FIG. 13 shows a closer view of the fuel diverter that has a much smaller radius by the end of it, as it wraps around the circumference of the bottom of the engine.

FIGS. 14A and 14B show cross sections of typical cooling channels and their heat transfer properties.

FIGS. 15, 16, and 17 depict trapezoidal passages as cross-sectional areas of cooling passages, in and according to some embodiments of the present disclosures.

FIG. 18 shows a bean shape for a cross-sectional area of the cooling passages, according to some embodiments.

FIG. 19 shows a semi-transparent, perspective view of an engine, revealing the coolant channels within the walls of the thrust chamber, according to some embodiments.

FIG. 20 illustrates how the top portions of the cooling passages may be shaped more like circles or ovals.

FIG. 21 shows a top-down view of the regenerative cooling passages at the connection of a combustion chamber to an injector plate, according to some embodiments.

FIGS. 22-24 show different views of how the pitch, cross-sectional shape, and sizes of the cooling passages may change as the channels flow up along the chamber walls of a structure, according to some embodiments.

FIG. 25 depicts an example of a cross-sectional area of a bean coolant channel.

FIG. 26A shows what a cylinder wall looks like with rectangular coolant channels, while FIG. 26B shows an example of what the cylinder looks like with bean-shaped channels.

FIG. 27 shows the thermal contours for the results of the rectangular cross sectional channel.

FIG. 28 shows the thermal contours for the results of the circular cross sectional channel.

FIG. 29 shows the thermal contours for the results of the bean-shaped cross sectional channel.

FIG. 30 shows magnified visual results of the rectangular cross section to accentuate the temperature banding.

FIG. 31 shows magnified visual results of the circular cross section to accentuate the temperature banding.

FIG. 32 shows magnified visual results of the bean-shaped cross section to accentuate the temperature banding.

FIGS. 33 and 34 show an example of a flat plate from different angles having bean-shaped coolant channels, according to some embodiments.

FIGS. 35 and 36 show a flat plate on the top surface with bean-shaped coolant channels, but with a wavy surface on the bottom that coincides with the concave geometry of the bean shapes.

FIG. 37 shows a flowchart of an example methodology for developing a structural heat exchanger having any number of coolant channels, with any variety of cross-sectional shapes, built to satisfy varying needs of a variety of industrial applicabilities, according to some embodiments.

FIGS. 38 and 39 show simulation schematics of portions of the fluid passages, according to some embodiments.

FIG. 40 is a side view of the main portions of fractal fluid passages to supply liquid oxidizer to the injector interface, according to some embodiments.

FIG. 41 shows a simulation rendering of a quarter armature of the liquid oxidizer passages, according to some embodiments.

FIG. 42 shows another example fluid passage design for the liquid oxidizer, according to some embodiments.

FIG. 43 shows a schematic of the liquid oxidizer fluid passages shaded according to fluid velocity, according to some embodiments.

FIG. 44 shows a schematic of the liquid oxidizer fluid passages shaded according to turbulent kinetic energy, according to some embodiments.

FIG. 45 shows a schematic of a different angle of the liquid oxidizer fluid passages shaded according to fluid velocity, according to some embodiments.

FIG. 46 shows a schematic of a different angle of the liquid oxidizer fluid passages shaded according to turbulent kinetic energy, according to some embodiments.

FIG. 47 shows a schematic combining both sets of the liquid fuel passages and the liquid oxidizer passages into the injector interface, according to some embodiments.

FIG. 48 shows the opposite side of the injector interface, showing the ultimate arrangement for how the orifices are positioned to inject liquid into the combustion chamber, according to some embodiments.

FIG. 49 shows a close up view of two triplet elements and one quadlet element.

FIG. 50 shows three different scenarios for choices of arranging which type of liquid at which type of angle in the quadlet.

FIG. 51 shows a perspective view of an example of a decreasing radius annulus diverter design incorporated into the fractal fluid passages for the liquid oxidizer.

FIG. 52 shows a top-down view of the example fluid diverter employed in the liquid oxidizer fluid passages design.

FIG. 53 shows a bottom-up view of the example fluid diverter employed in the liquid oxidizer fluid passages design.

FIG. 54 shows one side view of a CAD rendering of the example fluid diverter employed in the liquid oxidizer fluid passages design.

FIG. 55 shows an opposite side view of the CAD rendering from FIG. 54.

FIGS. 56-61 show various views of another example of a decreasing annulus fluid diverter as part of the design for the fractal fluid passages leading to the injector orifices, according to some embodiments.

FIG. 62 shows aspects of the nozzle that may be produced using additive manufacturing techniques.

FIG. 63 features emphasis on the engine flange.

FIG. 64 shows an illustration emphasizing Army/Navy (AN) fittings for portions of the engine.

FIG. 65 is a block diagram illustrating components of a machine, according to some example embodiments, able to read instructions from a machine-readable medium and perform any one or more of the methodologies discussed herein.

### DETAILED DESCRIPTION

Coolant systems for various engines, like thrust chambers, rely on traditional, subtractive, manufacturing methods for their production. As a result, their designs reflect the limitations of the manufacturing methods employed. Thrust chambers are typically created in more than one piece, and are welded or fastened together, using o-rings or other gaskets to seal high pressure regions. These designs exhibit numerous failure points. The need for high customization and a desire for engines to meet specific objectives has created a market for tailored engine designs.

Producing coolant systems through additive manufacturing (AM) offers a multitude of previously unseen improvements. The ability to print a series of heat exchanger channels in a single piece using AM techniques increases durability and usability while reducing weight. The speed at which additive manufacturing methods are able to produce components outpaces even the most agile traditional manufacturing operation, as well. The ability to produce novel geometries, which were not previously achievable using traditional manufacturing, has opened the door to countless performance improvements.

Indeed, the additive manufacturing approach enables the production of even the most complex geometries. This allows designers to create optimized structures without the burden of designing for traditional manufacturing techniques.

Aspects of the present disclosure are presented for a combustion engine design with an optimized amount of materials used to generate the necessary components of the engine. The engine may be generated as a single piece, having no joints, fasteners, or any other areas that could present a risk for damage. The designs described may also reduce weight of the engine, due to eliminating the need for fasteners and other extraneous hardware. In general, the weight of the engine may be optimized to also preclude the inclusion of extraneous material around needed structures. Also, the engine may be designed to be highly energy efficient, with optimal flows for fuel and other fluid with minimal head loss while maintaining higher pressures.

In some embodiments, the combustion engine may include other novel properties. For example, cooling passages of the engine may be designed to travel at changing pitch angles to increase or decrease cooling properties at points in the combustion chamber that experience higher or lower thermal stress. In another example, fluid passages for liquid fuel and/or liquid oxidizer may be provided in a fractal branching fashion with curvature to minimize turbulence and optimize distance traveled. As another example, one or more fluid diverters may be included with a design to generate substantially uniform pressure drop for all exiting fluid passages, even for those passages that exit the diverter the farthest along the main channel.

In some embodiments, a structural heat exchanger design with optimal heat transfer and cooling properties are included that may be created using additive manufacturing techniques. The heat exchanger may be generated as a single piece, having no joints, fasteners, or any other areas that could present a risk for damage. The heat exchanger may be built as part of an overall engine design, still as a single piece. The designs, and principles for deriving the designs, as described herein may also reduce weight of the engine, due to eliminating the need for fasteners and other extraneous hardware. In general, the weight of the engine may be optimized to also preclude the inclusion of extraneous material around needed structures. Also, the engine may be designed to be highly energy efficient, with optimal flows for fuel and other fluid with minimal head loss while maintaining higher pressures.

In some embodiments, a structural heat exchanger is presented that utilizes liquid fuel as a coolant as it travels through the perimeter of a high temperature engine chamber, like a combustion chamber or a thrust chamber. The shapes of the coolant channels, starting from the fuel diverter and flowing through the heat exchanger passages, may be configured to change angles as it travels to the top of the high temperature engine chamber, to account for areas of the chamber that may demand higher cooling properties. In some embodiments, the fuel diverter that allows initial passage of the fuel through the coolant channels may be configured to drive passage of the fluid up through the coolant channels with uniform pressure, even as the volume of fluid decreases the farther the fluid travels from the initial entry point. In some embodiments, this may be implemented as a fuel diverter shaped in an annulus with a gradually decreasing radial cross-section.

In some embodiments, the cross-sectional area of the coolant channels may be specifically shaped to satisfy certain objectives or boundary conditions. For example, a boundary condition may specify that the coolant channels should produce uniform thermal flux, to reduce heat strain on any particular point along and within the walls of the thrust chamber. In some embodiments, this may be achieved by generating the coolant channels to have cross-sectional areas in the shape of a trapezoid, or in other cases a bean shape. In some embodiments, the trapezoidal or bean shape of the coolant channels may be gradually converted to an oval or circular shape along the course of the channel, such as toward the top of a thrust chamber, as the coolant channels approach the fuel injector portion of the engine and the fluid is about to be dispensed.

In some embodiments, a method is presented for deriving designs of the coolant channels based on satisfying multiple boundary condition properties. These properties can include having an inner wall meet a certain heat flux condition, having the wall containing the channels meet a certain heat capacity, having a certain portion of the channels reach a particular pressure condition, and changing these properties at various different locations along the path of the channels, to meet various needs at particular locations.

In some embodiments, a structural heat exchanger includes a plurality of coolant channels that have varying cross-sectional areas. In addition, for any single coolant channel, the cross-sectional area may change shape gradually, to satisfy changing boundary conditions at those locations. In some embodiments, the layout of the coolant channels may be in the shape of a cylinder, a flat plate, a wavy plate, or other arrangement consistent with the principles of the present disclosure.

The structural heat exchanger according to various embodiments described herein may be used in a wide variety of non-limiting industrial applications, including: gas generator turbomachinery, power generation heat exchanges, automotive engines, HVAC units, server cooling modules, and applications with needs for high performance heat exchange, like power plant reactors and various vehicles with high demand for power.

In some embodiments, a rocket engine design is presented with optimized fluid passages for ensuring proper mass flows that may be created using additive manufacturing techniques. The engine may be generated as a single piece, having no joints, fasteners, or any other areas that could present a risk for damage. The designs are described may also reduce weight of the engine, due to eliminating the need for fasteners and other extraneous hardware. In general, the weight of the engine may be optimized to also preclude the inclusion of extraneous material around needed structures. Also, the engine may be designed to be highly energy efficient, with optimal flows for fuel and other fluid with minimal head loss while maintaining higher pressures.

In some embodiments, the fluid passages that feed into the injector, including the liquid fuel passages and the liquid oxidizer passages, are arranged in a branching fashion, not unlike the shapes of tree roots or branching blood vessels. Generally, the fluid passages are designed with smooth, continuous curvature, compared to conventional methods that introduce sharp, perpendicular channels, so as to reduce turbulent flow of the fluid while changing directions. Methods used to develop the fluid passages may have been constrained to develop passages that reduce turbulence and create evenly distributed fluid pressure through each of the passages.

In some embodiments, the injector interface that defines the end of the fluid passages may include an intermingling of liquid oxidizer and liquid fuel orifices in novel and non-obvious arrangements. In some embodiments, the injector interface includes a plurality of triplet and quadlet injector sets, with the fluid designed to enter the thrust chamber at carefully designed angles that improve burn efficiency and reduce temperatures at the wall surfaces.

In some embodiments, the fluid passages are designed to also reduce the impact of pressure waves that are an inherent byproduct of the fuel combustion used to generate thrust. For example, the fluid passages may be designed to branch off into smaller passages at staggered depths, rather than have all passages branch off at the same height or depth that may be seen in typical manufactured designs, due to the convenience in manufacturing that way. These asymmetries may create destructive interface when the pressure waves hit, that effectively raises the resonance frequency of the engine overall, thereby reducing the impact of the pressure waves.

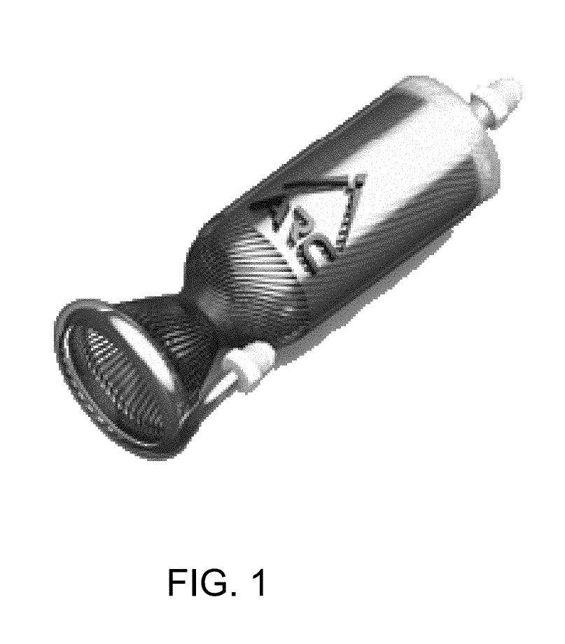

FIG. 1 is an illustration of an example series of coolant channels of a structural heat exchanger, housed in an engine, according to the present disclosures. As shown, the coolant channels are manufactured as a single piece—as is the entire engine overall—with no fasteners or other components required to ensure the engine stays put together. Many of the novel and inventive features will be described more, below.

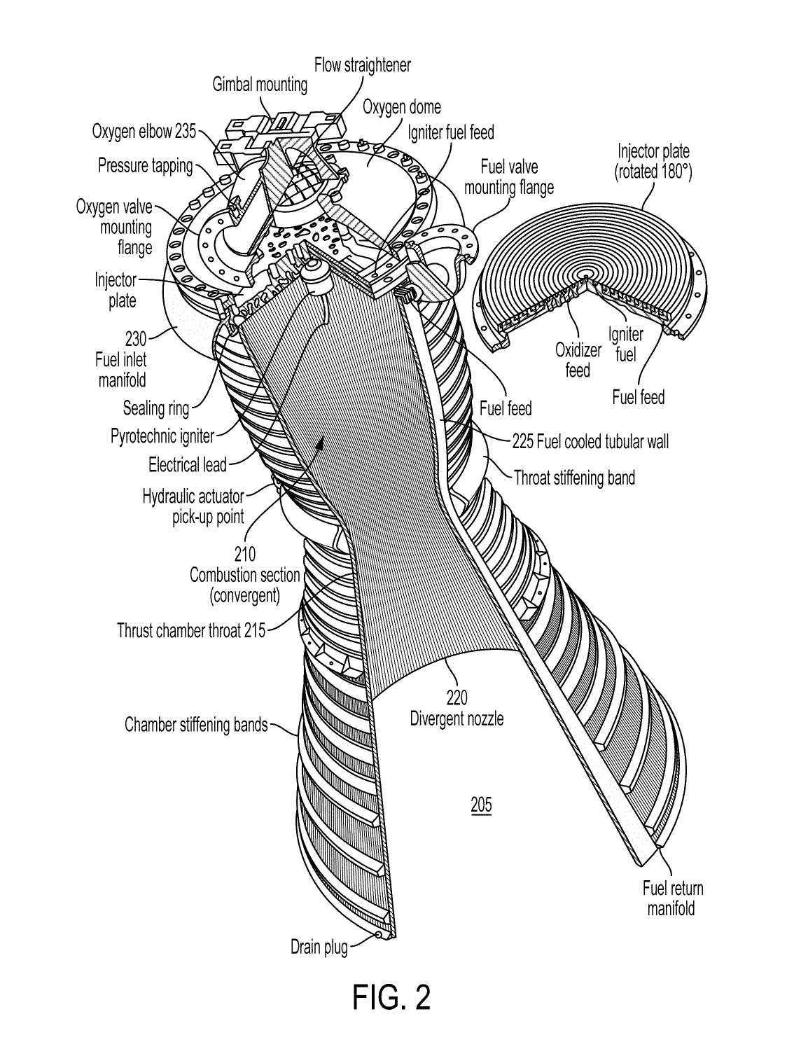

FIGS. 2-7 and related descriptions provide a description of a traditional engine designs that supply context for coolant channels in a heat exchanger and serve as a point of comparison to highlight the novel and nonobvious features of the present disclosures.

Referring to FIG. 2, an example schematic of a traditional rocket engine design, including the thrust chamber and injector, is shown. Bi-propellant liquid rocket engines have existed since the 1930s and their technology peaked between 1960 and 1985. During this time, engines such as the Rocketdyne F1, Pratt & Whitney RL-10, Rocketdyne RS-25 (Space Shuttle Main Engine), and the Soviet built RD-170 and RD-180 engines were produced. Each of these engines were unique in their own right. The F1 was a bi-propellant engine that used liquid oxygen (LOX) and kerosene (RP-1) in a gas generator thermodynamic cycle. The RS-25 is a liquid hydrogen (LH2) and LOX engine that uses a staged combustion cycle. The other rockets mentioned use various cycles and propellant combinations, but the one thing that is the same across the board is that these engines are incredibly complex, very large assemblies. Each engine is built using parts that are fabricated in a machine shop, and then assembled on an assembly rig. While all of these engines represented the forefront of technology at the time, the mere fact remains that they are built from hundreds or thousands of individual parts instead of one piece.

Typically, propellant is delivered through the injector into the combustion chamber. In the combustion chamber, the propellant is ignited. It accelerates subsonically through the converging section of the nozzle until it reaches the throat. At this point it reaches Mach 1. The propellant then accelerates through the diverging section of the nozzle until it is exhausted out of the nozzle exit at very high speeds (often in excess of Mach 3). Thrust is produced via the principle of conservation of momentum. The high velocity propellant exerts a reaction force on the thrust chamber in the direction opposite of the flow.

In general, the major features of a thrust chamber include:

### 1) Combustion Chamber (205)

### 2) Converging Section (210)

### 3) Throat (215)

### 4) Diverging Section (220)

5) Coolant Manifold (if using regen cooling) (225)

The major features of the injector include:

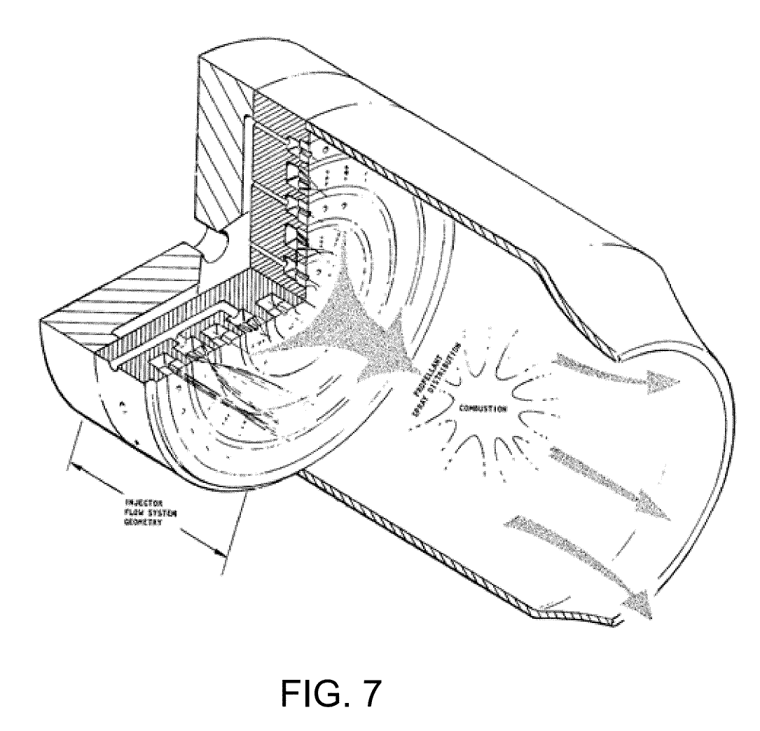

### 1) Pattern of Injection Orifice Elements (see FIG. 7)

### 2) Fuel Manifold (230)

### 3) Oxidizer Manifold (235)

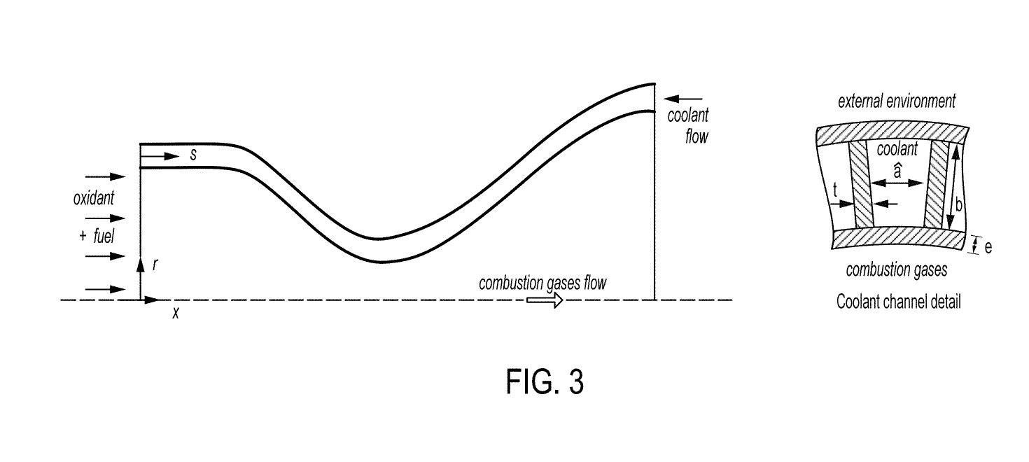

FIG. 3 shows a schematic of an azimuthally cross-sectional view of some features of the thrust chamber. Here, typical thrust chamber contours are shown with regenerative cooling channels. It can be seen that the coolant channel cross-sectional area is roughly in the shape of a rectangle or trapezoid with sharp corners.

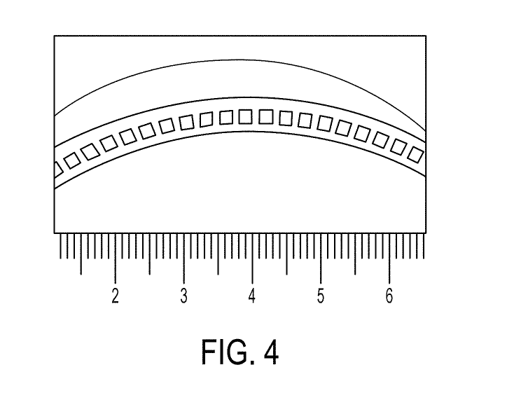

FIG. 4 shows a wider example of the cross-sectional shape of typical regenerative cooling channels, using traditional manufacturing. Here, multi-material traditional manufacturing tends to result in rectangular regen cooling channels.

Traditional “regen” cooling passages were either built from tubes that were formed and then brazed together (creating the iconic “spaghetti” nozzle seen in the F1 and RS-25), or milled from a solid piece of metal as seen in the Soviet era Russian engines. Creating tubes and then brazing them together was immensely time consuming and large amounts of material were often wasted as the fabrication process almost always required repair or rework. Milling, while simple, requires a large, heavy piece of metal that creates a lot of waste, and then requires forming an outer wall out of sheet that is diffusion bonded to the inner structure. This is very time consuming. Traditional regen cooling passages do not allow much in the way of curvature or shape morphing. Even though precise techniques are used to create these channels, the rectangular shape has in several ways, significant flaws in heat flux properties that can put dangerous strain at certain places in the chamber walls.

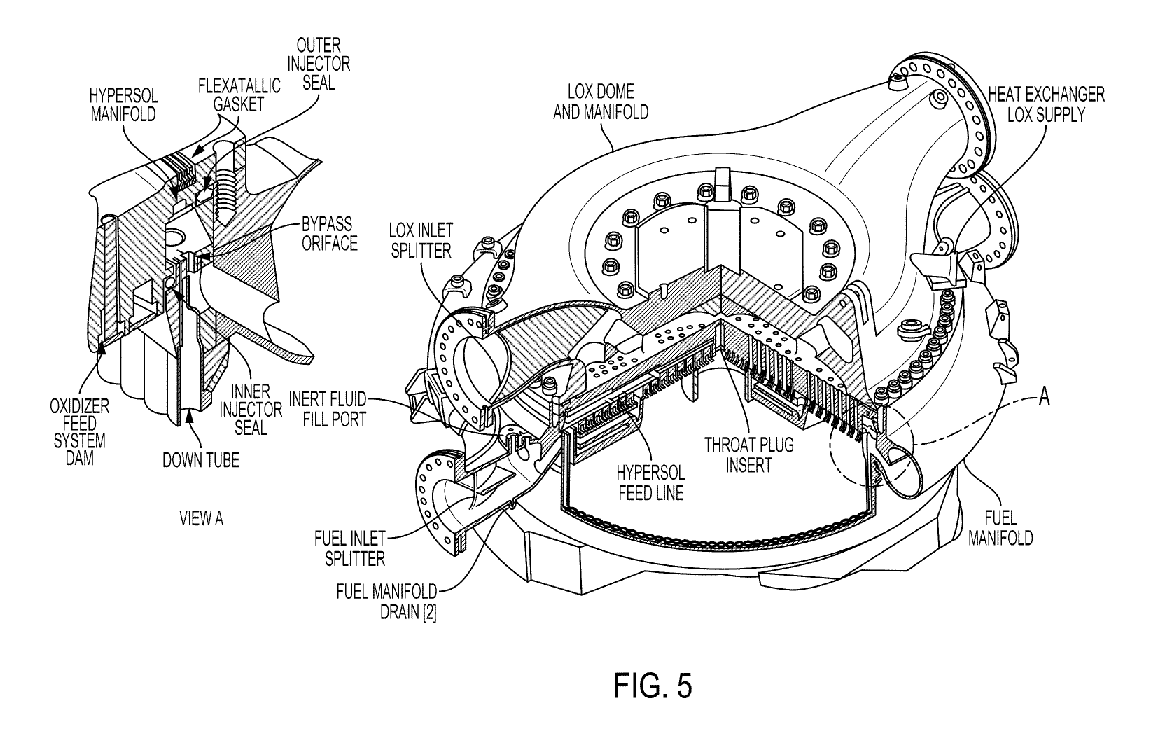

FIG. 5 shows an example schematic of a typical F-1 engine injector geometry.

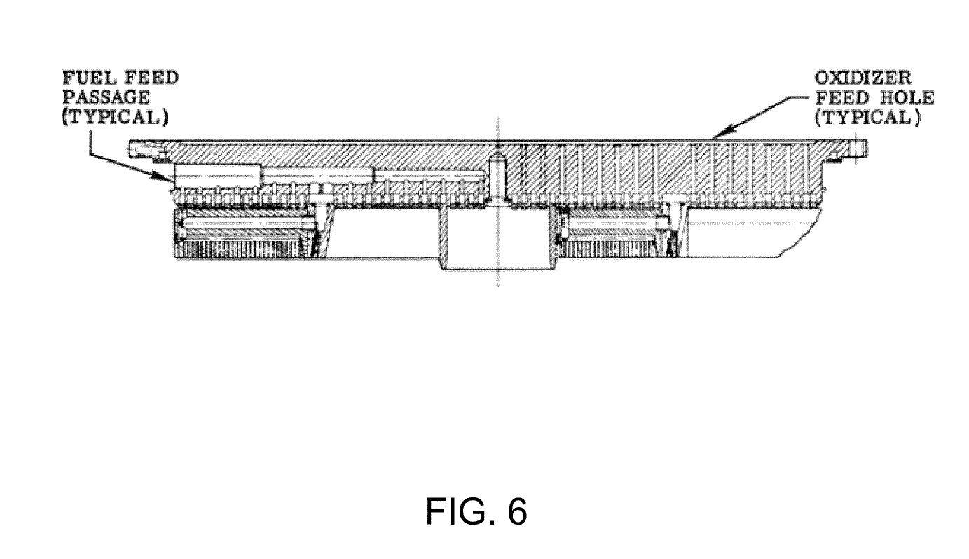

FIG. 6 shows an illustration of an example of a typical injector plate collection chamber and orifice.

FIG. 7 shows an example of a typical injector flow system with collection chamber geometries. As shown, the fuel injector orifices are simple in design, yet still very difficult to manufacture. All the while, the designs are not optimal, as the fuel is likely to be injected at uneven rates or pressures, depending on stochastic movement for how the fuel would travel on top of the fuel injector plate before falling into the injector orifices.

Consistent the examples shown in FIGS. 5, 6, and 7, a typical injector would consist of a dome for distributing cryogenic oxidizers to the oxidizer orifices of the injector. Due to high levels of turbulence present in the dome and the potential for fluid phase change, engine ignition procedures have been implemented in order to ensure that all gaseous oxidizers has exited the system. Nevertheless, turbulence within the dome can yield unexpected flow to the numerous oxidizer orifices of the injector.

Fuel manifolds in a standard injector rely on collection chambers for pressure equalization in order to simplify flow calculations and reduce manufacturing costs. The result is rectangular channels with orifice feed channels extending perpendicular. Since collection chamber inlets do not follow the symmetry of the collection chamber itself, turbulence causes pressure drops within the chamber which also lead to nonuniform flow to the orifices.

In addition, standard manifolds are susceptible to combustion instabilities due to their resonant frequencies or may susceptible to pressure wave oscillations which may cause combustion instabilities at low upstream pressures. As a result, collection chamber manifolds deliver positive feedback, increasing the intensity of the instability.

Typically, common element patterns are chosen and arranged for ease of subtractive manufacturing and manifolding and manufacturing, not to optimize propellant mixing and performance. These requirements can be in conflict with one another which may cause deficits in performance or manufacturing.

As previously mentioned, aspects of the present disclosure provide for a structural heat exchanger with regenerative coolant channels, typically housed in an engine that is designed and manufactured in ways that address any and all of these issues found in typical engine design and manufacturing.

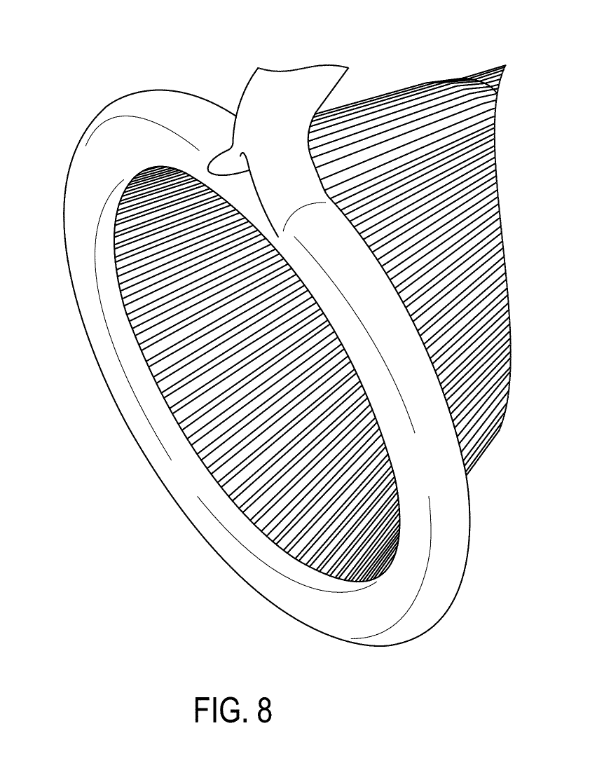

Referring to FIGS. 8-13, embodiments of a fuel diverter are discussed that address a number of the issues described, according to some embodiments.

Referring to FIG. 8, a fuel diverter with a uniform annular radius is shown. The fuel diverter may be positioned at the bottom of the engine, to allow fuel to flow up along the walls of the engine to act as coolant before the fuel is injected at the top of the chamber. The grayscale gradient shows a turbulence simulation of regenerative cooling through an additively manufactured engine. Non-uniform turbulence present in the diverting section of this engine indicates an ineffective diverter design.

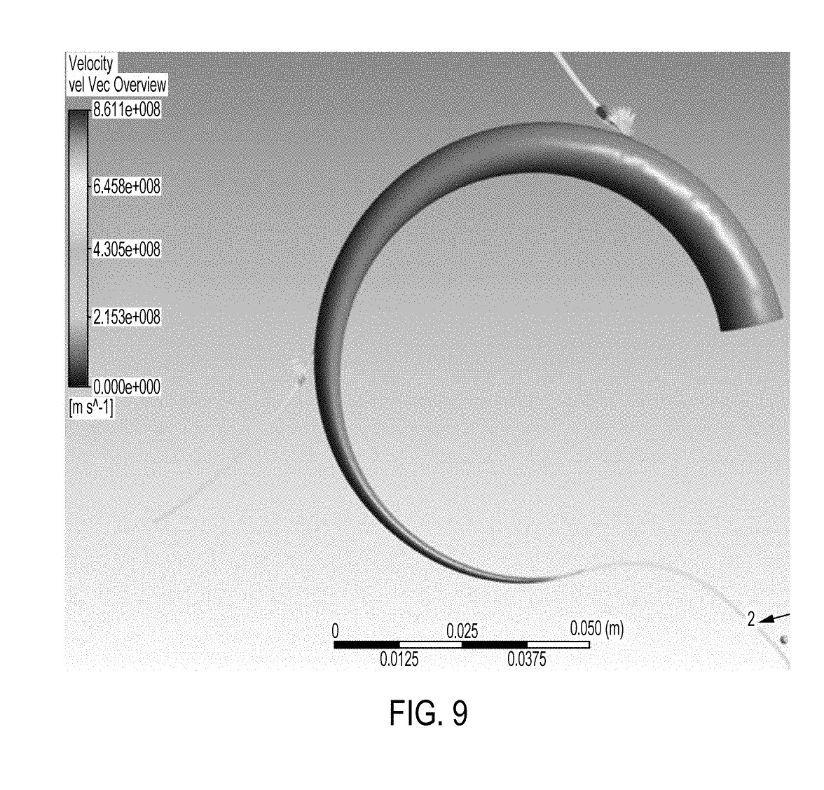

Referring to FIG. 9, a fuel diverter in the shape of a decreasing radius annulus is presented, according to some embodiments. In order to reduce turbulence and ensure an equal mass flow of fuel to each of the regenerative cooling channels that are fed by the fuel diverter (e.g., 48 total cooling channels), a decreasing radius annulus fuel diverter may be used. The annulus begins with a diameter equal to that of the fuel inlet and decreases proportionally to the amount of fuel that is diverted off into each of the branching channels. This results in a constant pressure annulus with equal mass flow delivered to each channel. This ensures the even cooling of the chamber wall by the regen cooling and subsequently, the proper distribution of fuel injected by the attached fuel injector passages. Standard diverting passageways do not account for pressure drops due to turbulence. This results in unexpected and uneven distributions of mass flows among the various identical diverting channels. Such a non-uniform distribution of fluid can result in potentially destructive engine hotspots and injector-induced combustion instabilities.

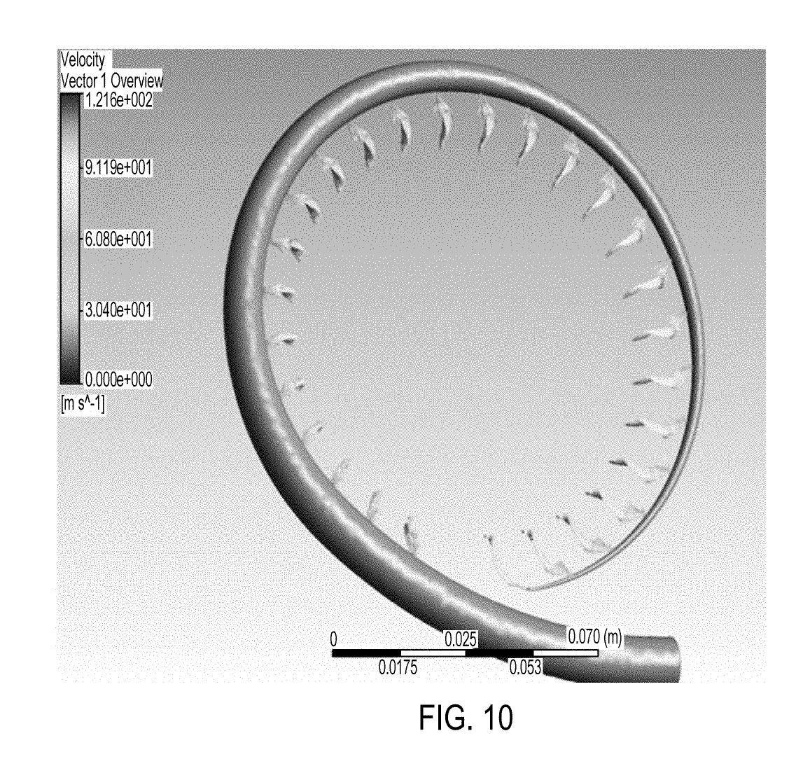

FIG. 10 shows an illustration of fluid being delivered through each channel out of the fluid diverter. The grayscale gradient shows that the pressure drop at each passage is identical, which is in part due to the decreasing radius of the annulus.

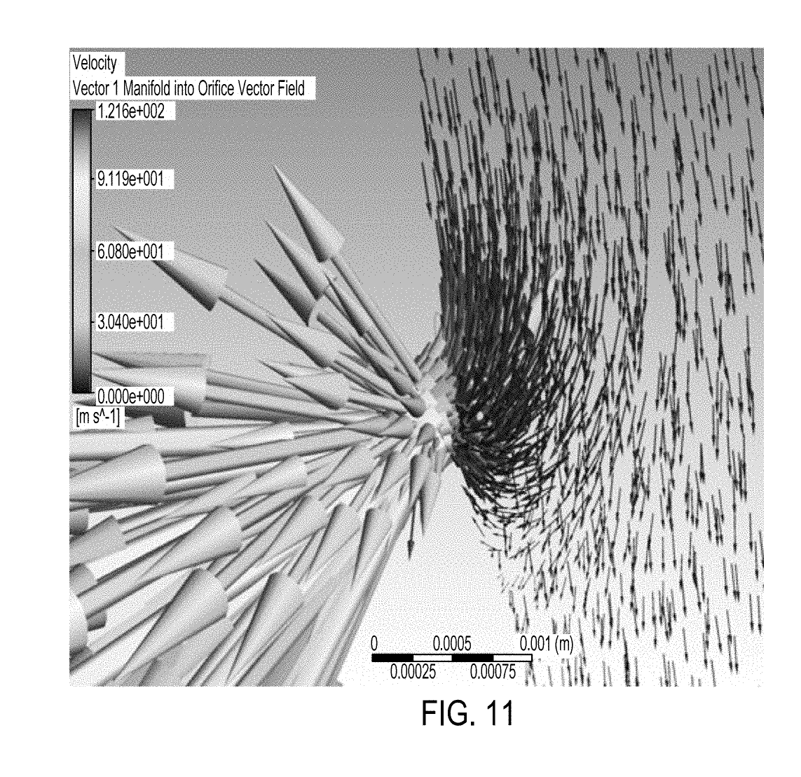

FIG. 11 shows an illustration of a flow vector simulation of the direction and magnitude of the liquid as it enters the offshoot passages from the fluid diverter, according to some embodiments. As shown, the directions of the fluid offshoot are generally uniform, in that the turbulent flow is generally evenly distributed as it enters the passage. In addition, the magnitude of each flow vector is generally the same length, indicating generally uniform pressure as well. This illustration may be representative at each passageway, due to the decreasing radius of the fluid diverter.

In general, the diverter geometries depicted in FIGS. 10 and 11 demonstrate how the decreasing annular diverter can feed a desired mass flow rate to an arbitrary number of passages. It maintains a directional flow of fuel at all times where the flow direction and the fluid pathway, determined by the geometric domain, are maximally uniform. This design is capable of feeding many orifices with a desired mass flow rate. The branching orifices may be identical or may vary in size, if a specific non-uniform distribution of mass flows among the orifice is desired. The decreasing annular diverter is capable of maintaining the desired mass flow rates over a wide range of input conditions, such as pressure or mass flow rate. It can also be used to deliver optimal flow rates of various fluid phases, reacting, or unsteady flows, by taking these changes into account when producing a constant pressure annulus.

The diverter design of the present disclosures may also be applied to other fluid passages, according to some embodiments. For example, the decreasing radius annulus design of the diverter described herein may be applied to an injector orifice interface, or in general any set of fluid passages that utilizes one or few fluid entry points and delivers fluid to many or multiple fluid passages with substantially uniform pressure drop.

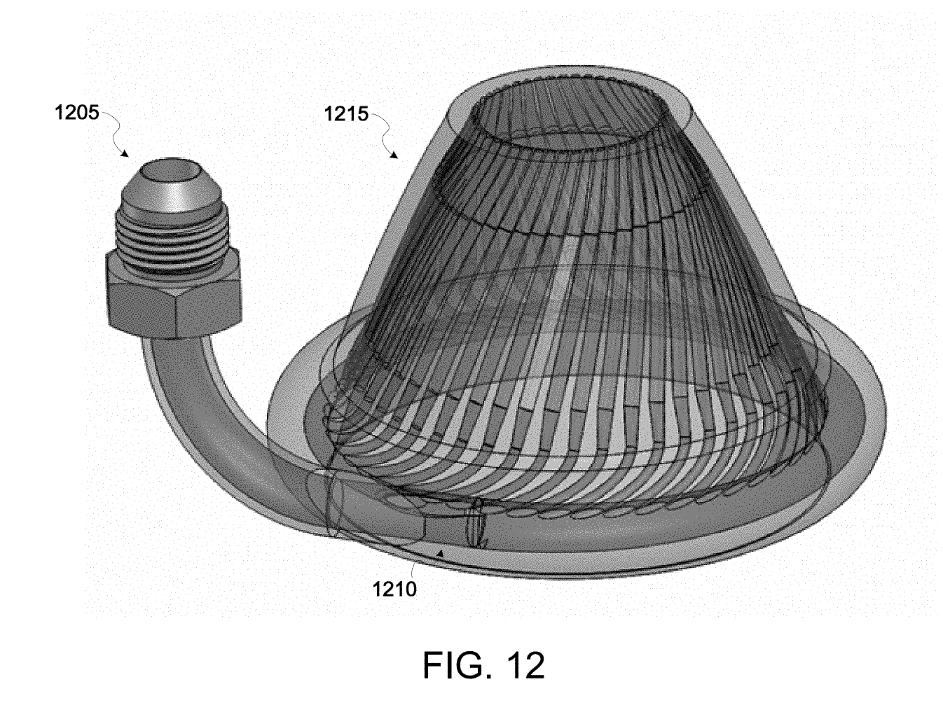

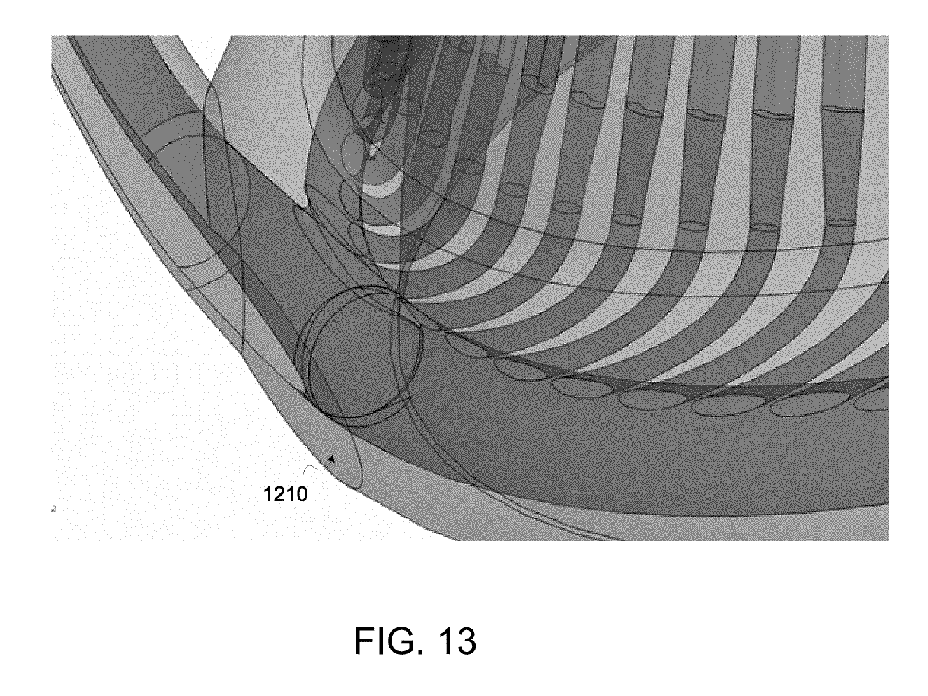

Referring to FIG. 12, shown is a semi-transparent view of the bottom of an engine, illustrating the fuel diverter 1210 in the context of other components, according to some embodiments. These include the fuel inlet 1205 and the nozzle 1215 portion of the thrust chamber. The multiple coolant channels are also shown, angling up toward the throat of the engine. As shown, and with a closer view in FIG. 13, the fuel diverter 1210 has a much smaller radius by the end of it, as it wraps around the circumference of the bottom of the engine. In some embodiments, the end of the fuel diverter may be connected to the beginning, to form a closed loop, while in other cases the ends are disconnected. FIG. 13 also shows how the fuel inlet is coupled to the entry passage of the fuel diverter.

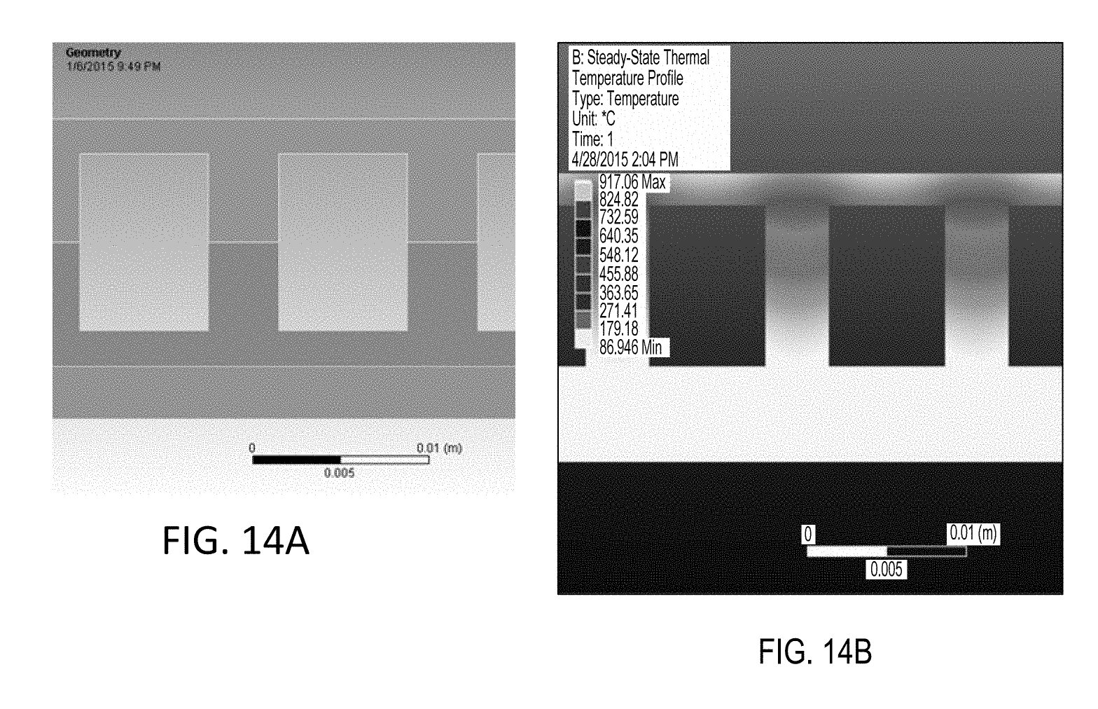

Referring to FIGS. 14A-24, embodiments of regenerative cooling channels are discussed that address a number of the issues described above, according to some embodiments.

Regenerative (or regen) cooling is widely used in liquid propellant engines as a means of removing heat from an engine chamber inner wall. Cooling channels reside within an inner wall, which may be contained generally in a casing or housing structure as part of the whole engine or other structure. A pressurised fuel or oxidizer is fed through the channels embedded within, or wrapped around, a chamber wall. The fuel/oxidizer is used as a moderating fluid into which heat flows. This process cools the chamber wall: preventing material degradation, melting, undesirable phase transitions or grain transformation, and increasing chamber longevity.

Standard regen cooling schemes include: wrapping the chamber in small fluid-transporting channels, manufacturing rectangular channels into the wall of the engine, and manufacturing circular channels into the engine wall. Additive manufacturing allows for the implementation of numerous advanced channel designs which may not be producible using traditional manufacturing methods.

Referring to FIGS. 14A and 14B, cross sections of typical cooling channels, and their heat transfer properties, are shown. Rectangular channels are commonly used because of their ease of fabrication and good heat transfer properties. Rectangular channels also provide a large gas-side wall surface area for increased heat transfer as opposed to other geometric shapes. However, this method is not optimal because of the poor temperature distribution caused by the rectangular shape. The sharp edges of the rectangular channels cause stress concentrations at the corners of each individual channel, as evidenced by the uneven color gradient at the corners in FIG. 14B. While stress concentrations caused by sharp edges are unfavorable, this method is still commonly used because of the ease of manufacturing.

Circular channels are structurally favorable according to certain criteria, since they distribute the pressure force in all directions, preventing stress concentrations. Similarly, the maximized surface area of a circular channel enhances heat flow into the moderating fluid. However, arrays of circular channels, distributed azimuthally about the axis of the chamber, produce uneven distributions of temperature along the inner wall off the chamber material itself, resulting in significant thermal stress.

While more optimal from a pressurized and thermal perspective, non-circular and non-rectangular geometries for the coolant channels are much more difficult to create using traditional manufacturing techniques. The performance, durability, and longevity benefits they provide are outweighed by increased manufacturing costs and additional pieces or components needed to create such advanced geometries. However, these geometries can be created rapidly and precisely through additive manufacturing at a very low cost.

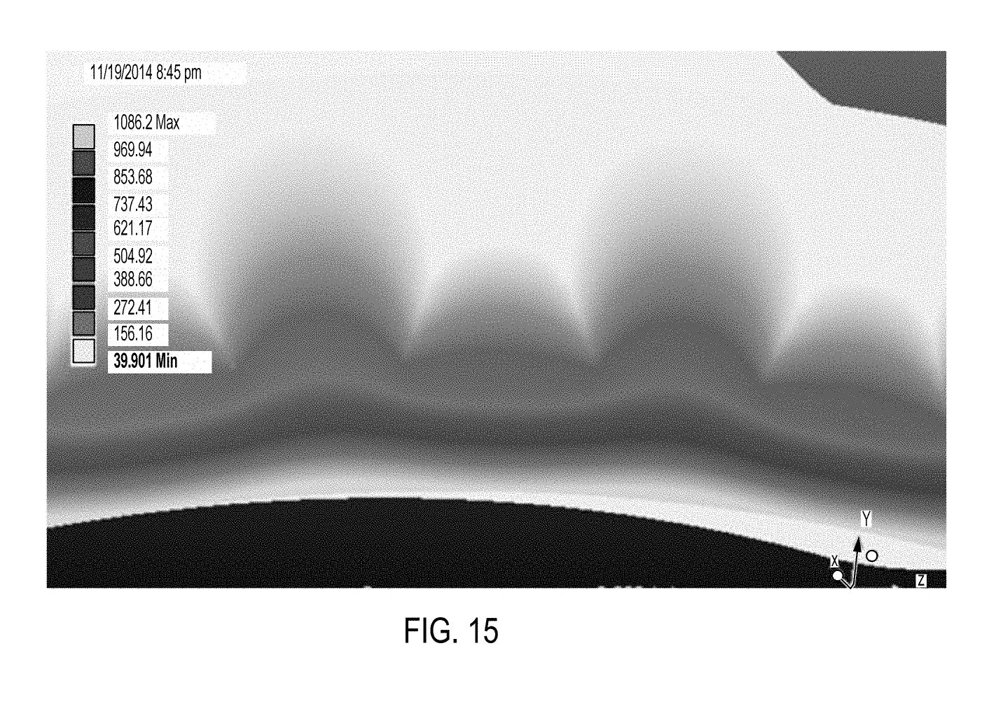

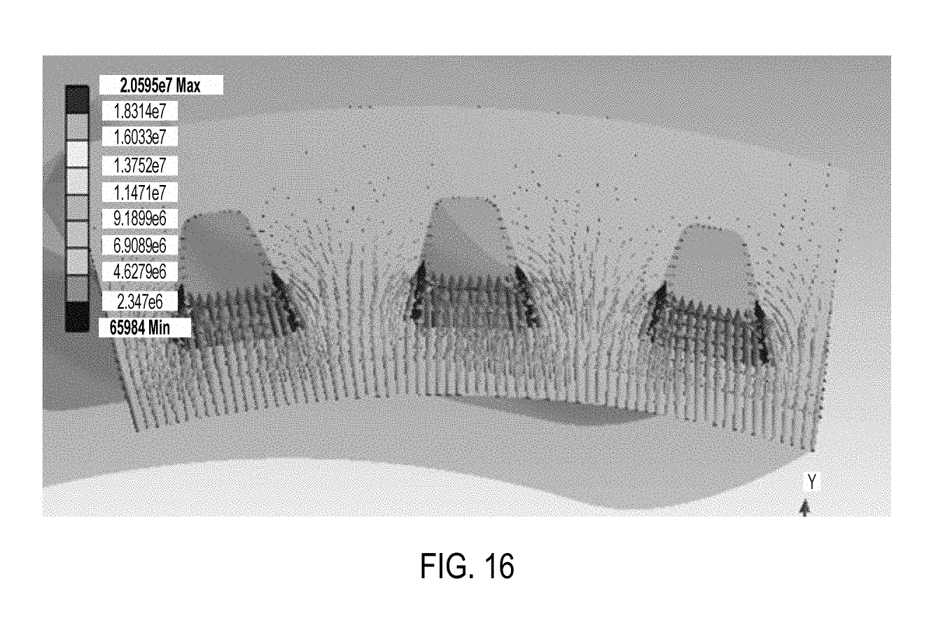

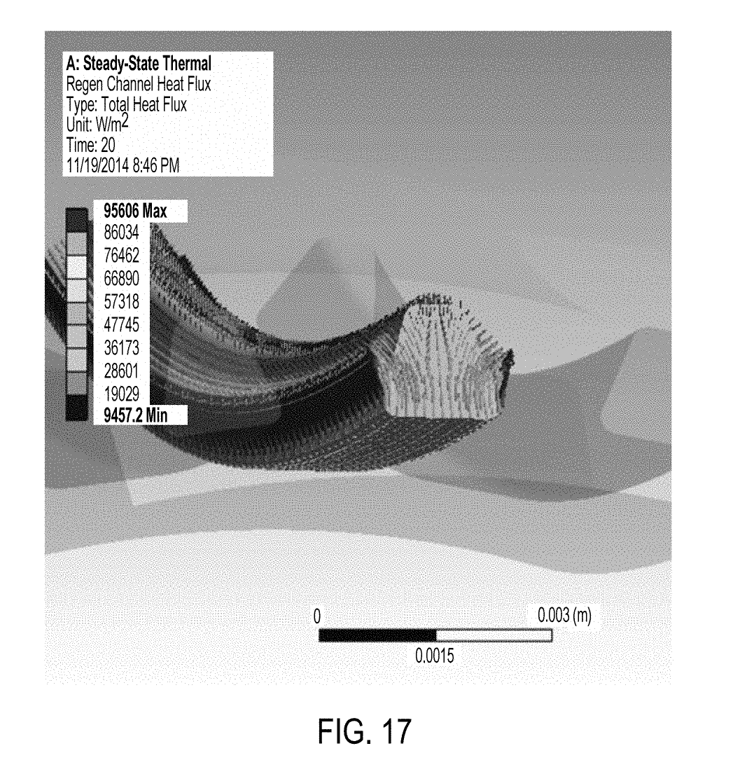

Trapezoidal passages depicted in FIGS. 15, 16, and 17 and according to some embodiments of the present disclosures, offer some benefits of both circular and rectangular passages. They are also easily producible through additive manufacturing. Greater gas side wall surface area enable greater heat transfer into the moderating fluid. Rounded edges and a narrowed cross section closer to the outer wall provides increased management of stresses due to high differentials in pressure, caused by the high fluid pressure within the channels, and thermal considerations, which lead to thermal stresses through spatial variances in thermal expansion. FIG. 15 depicts the thermal profile along the inner wall of a trapezoidal regenerative cooling channel during normal use. The trapezoidal channels reduce temperature gradients along the inner wall. FIG. 16 shows a graphical simulation of the thermal flux of trapezoidal coolant channels. As shown, the temperature gradients around the coolant channels are more even throughout, reducing any stress points along any corners or edges. FIG. 17 shows another illustration of the thermal flux in an elongated portion of the trapezoidal coolant channel design. Even when the channel is curved, the thermal flux properties remain constant along the same portion of the respective edges and corners.

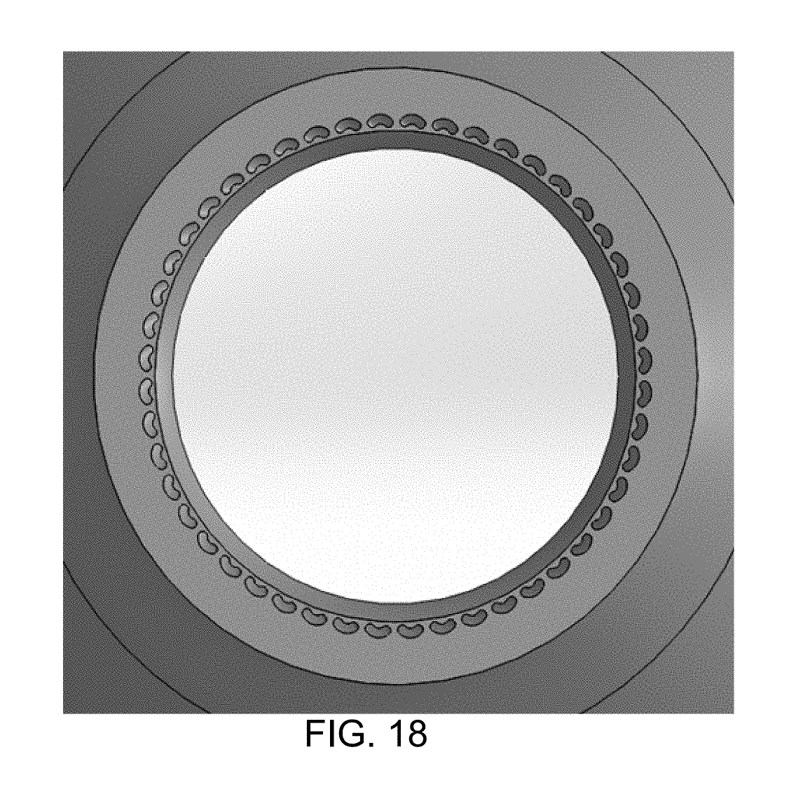

One novel idea for a regenerative cooling channel comes from the discovery that an even temperature profile could be achieved with a non-constant channel cross section. Through novel design methods, a cross section with a near-even temperature profile was created. This shape will be referred to as a “bean” shape, and one example implementation of the coolant channels with this shape is shown in FIG. 18. Pressure distribution is uniform within the bean channel. Distribution of equivalent stresses is not uniform throughout the wall section, but is optimized to a minimum by the bean channel for the given thermo-structural boundary conditions, according to some embodiments.

Other variants to the bean shape may be contemplated by the present disclosures herein, such as the cross-sectional area having a “macaroni” shape with the inner and outer wall edges of the coolant channel shaped in a parallel concave pattern (also like the bean), but with the lateral sides more straight (to look like the profile of a bent piece of macaroni), rather than curved (like the bean). Variants that gradually morph between these various shapes are also contemplated, as additive manufacturing can allow for each cross-sectional layer to gradually change shape between one another.

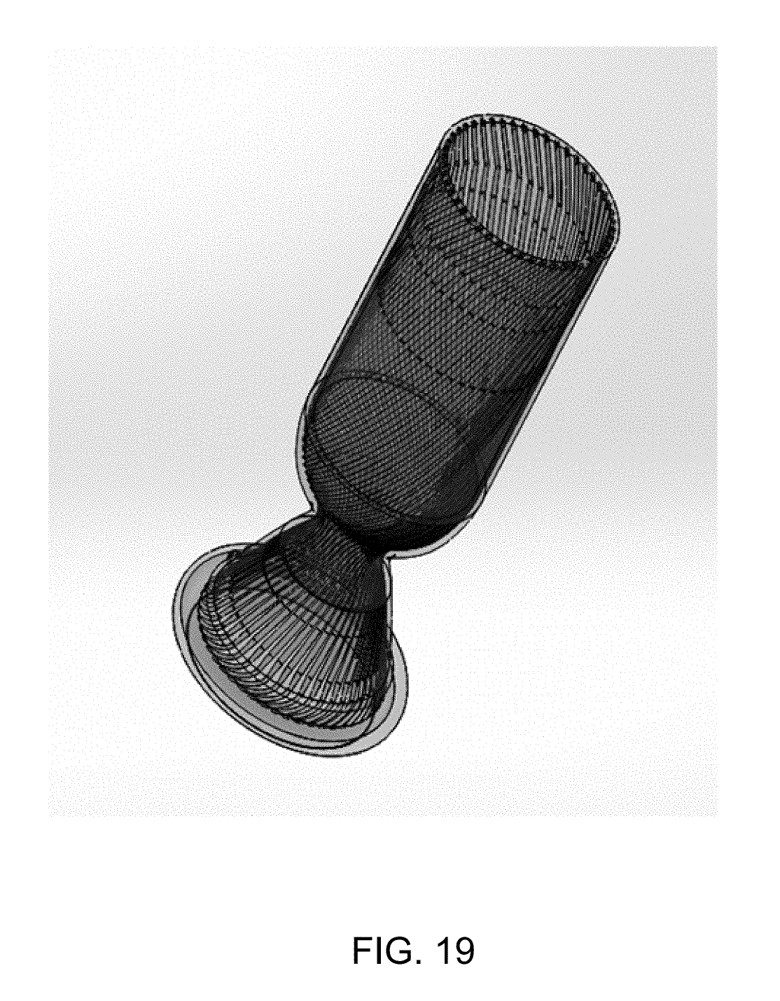

FIG. 19 shows a semi-transparent, perspective view of an engine, revealing the coolant channels within the walls of the thrust chamber, according to some embodiments. As shown, the cooling passages are angled and spiral upward to the top of the thrust chamber in a helical pattern. This will be described in more detail, below.

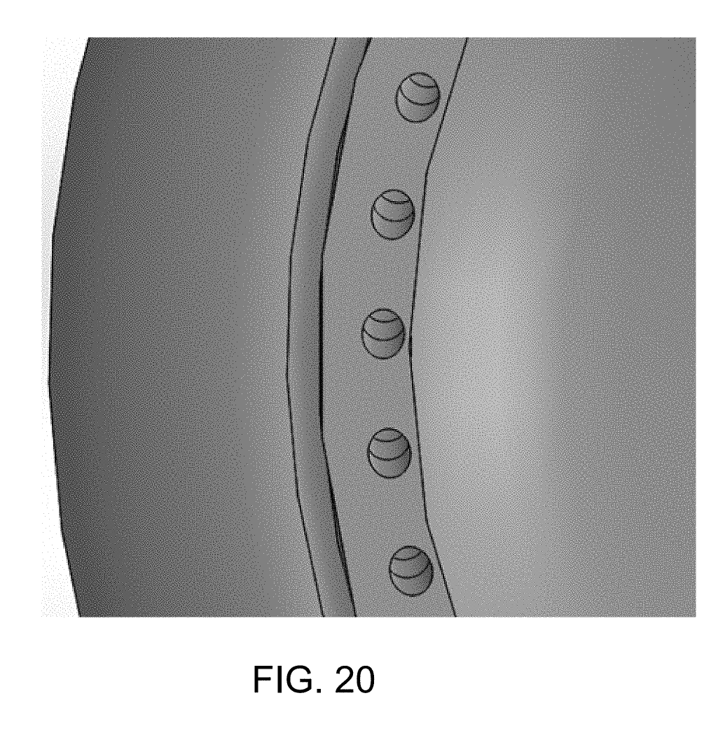

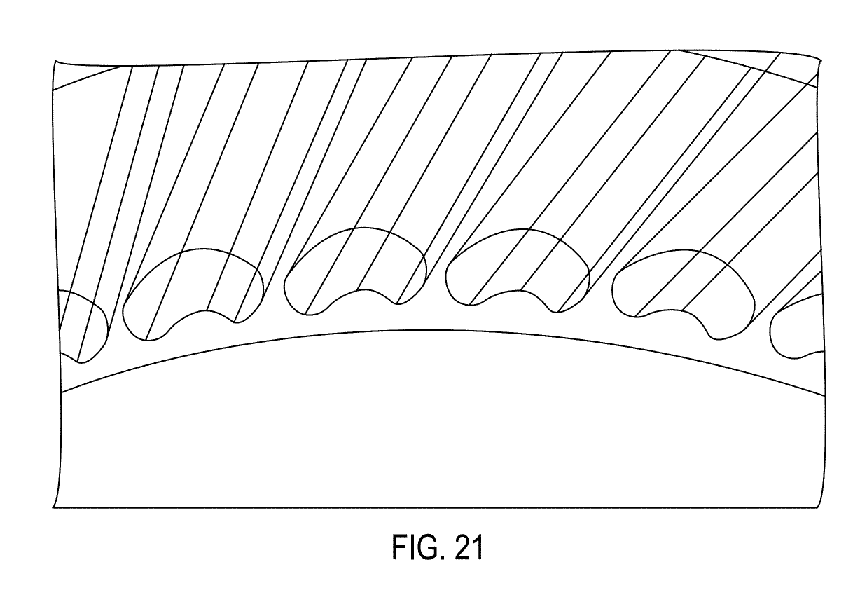

The middle portions of the cooling passages may be shaped to have a cross-sectional area according to one of the more optimal shapes for providing cooling, such as the trapezoid or the bean shape. As the cooling passages approach the top of the thrust chamber, however, there is less of a need to provide cooling, and more of a need to provide uniform pressure to prepare the fuel to be injected at the top of the thrust chamber for ignition. FIG. 20 illustrates how the top portions of the cooling passages may therefore be shaped more like circles or ovals, to account for this. Thus, in some embodiments, the cooling passages are designed to gradually transition from a shape designed for cooling and better heat transfer (e.g., trapezoid or bean shape) to a more uniform shape before the fluid finishes traveling. In addition, the shape of the passages toward the beginning of the passages, i.e., as the fuel is delivered from the fuel diverter to each of the cooling passages, may be more like the oval shape, and then may gradually change to the more cooling-optimal shape. These transitions will be described in more detail, below.

FIG. 21 shows a top-down view of the regenerative cooling passages at the connection of the combustion chamber to the injector plate, according to some embodiments.

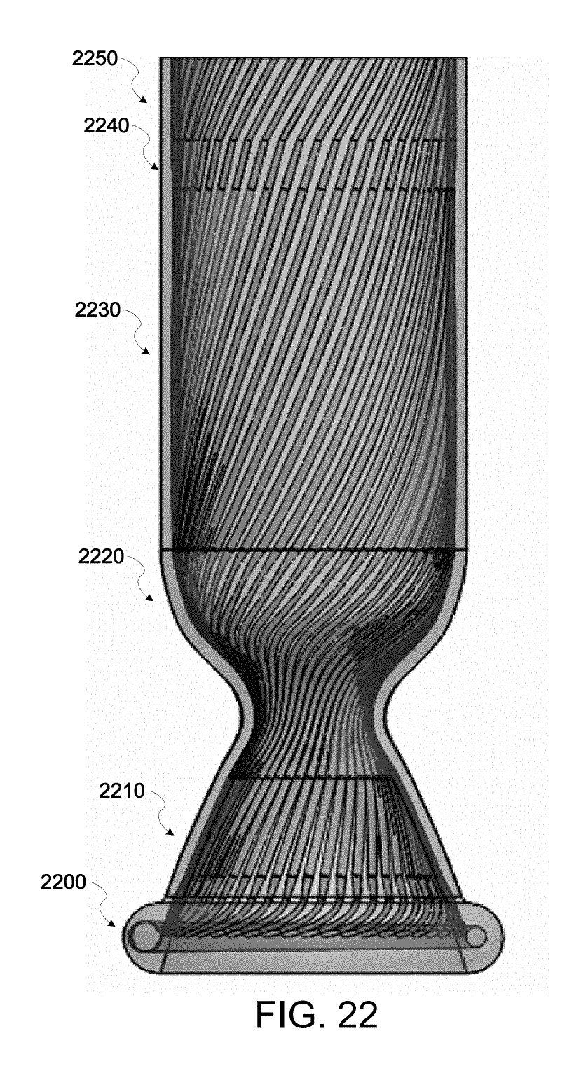

FIGS. 22-24 show different views of how the pitch, cross-sectional shape, and sizes of the cooling passages may change as the channels flow up along the thrust chamber walls, according to some embodiments. Typically, cooling channels using traditional manufacturing are never varied with any of these degrees. However, due to properties available in additive manufacturing techniques, these cooling channels can be adjusted in various ways to account for the different needs at different points along the engine walls.

For example, starting at the beginning of the fuel diverter in section 2200, the cross-sections of the channels may be shaped more like ovals or circles, as previously described. This may reduce turbulent flow into each of the channels as the fluid is being delivered from the fuel diverter into each of the channels. As the channels progress into section 2210, the shapes may be converted to the optimal cooling shape, such as the trapezoid, bean or macaroni shape. The pitch of channels may be more vertical, indicating less of a need to provide cooling surface area at this juncture. At section 2220, the channel pitch decreases at the throat to account for increased heat flux at the throat. The size of the channel cross section may also decrease at the throat to increase fluid velocity. Converging diverging channels at the throat increases fluid turbulence. Turbulence decreases the viscous boundary layer, increasing the average flow velocity of the moderating fluid near the wall. The fluid is allowed to flow faster, essentially wicking away heat more quickly. This enhances heat transfer from the wall into the cooling channel fluid.

As the cooling channels reach the elongated portion of the thrust chamber, at section 2230, there is less of a need for cooling compared to the throat portion 2220, and so the pitch of the channels may be made more vertical again, and the size of the channels may be increased again. At section 2240, as the channels begin to approach the fuel injector portion of the engine, the cross-sections of the channels may be converted back to a more uniform shape, like a circle or oval. Finally, at section 2250, with the passages now securely shaped uniformly, the pitch of the channels may be decreased again, to prepare for the proper angle of entry into the fuel injector region.

In general, variations in channel cross section shape, size, and pitch can be used to specifically tune the turbulence and therefore the heat transfer. This can be used to control the heat transfer as well as the temperature and pressure of the moderating fluid. This is particularly important for ensuring that the temperature and pressure of a supercritical moderating fluid is past the critical point and gasification or liquidation is avoided, as these are potentially damaging to the engine. Increasing and decreasing the cross sectional area of the channel enables the axial optimization of heat transfer into the fluid.

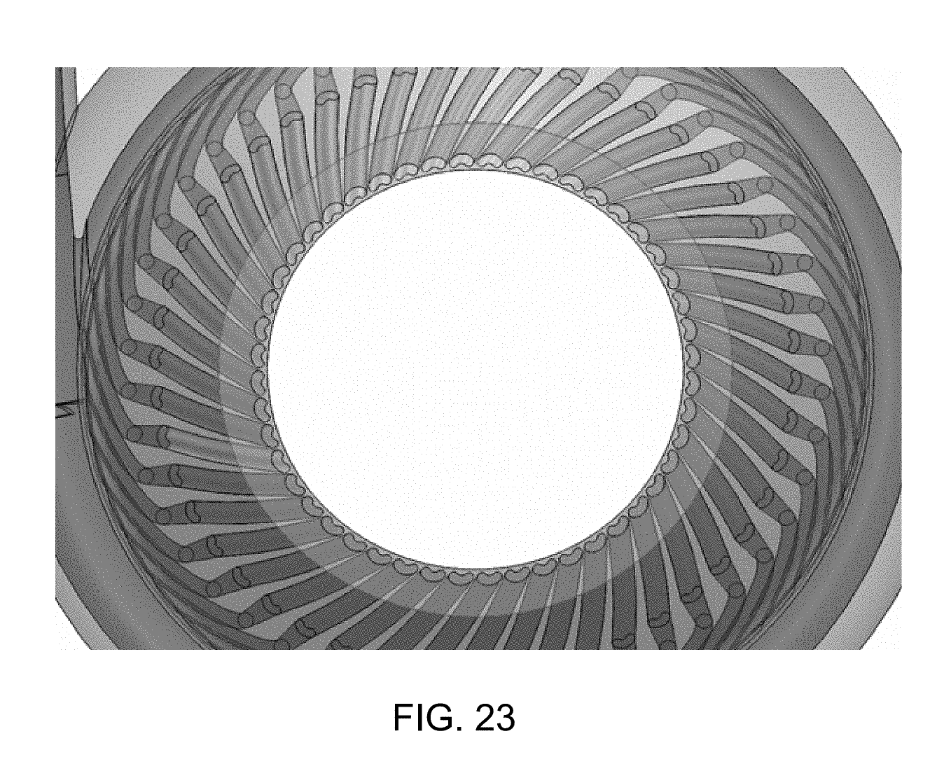

FIG. 23 shows a bottom-up view of the cooling channels, with their different pitch angles and shape changes at the varying sections, according to some embodiments. This view shows just the portion rising into the throat, as the remaining portions of the channels flowing out of the throat widen and thus would be out of view. From this perspective, the changing angle along a single channel indicates a changing pitch, as described in FIG. 22. Also, it can be seen that the cross-sectional area of a single channel changes, from a circular area to a bean shape.

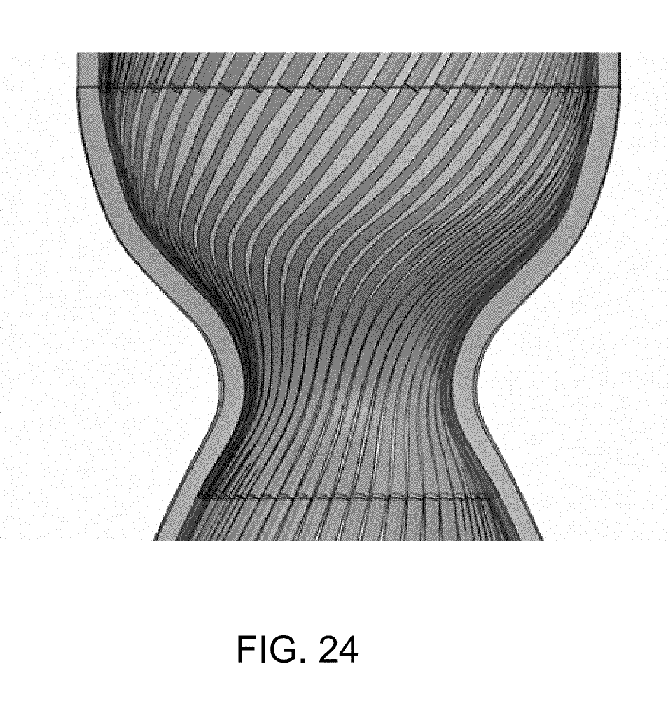

FIG. 24 shows a closer view of the throat area of the cooling passages, according to some embodiments. As shown, cooling passages are arranged helically, and at this juncture, the pitch angle is changed to be more horizontal (i.e., increased), in addition to the passages being closer together, as well as the sizes of the channels decreased. In general, none of these properties are easily reproducible using traditional manufacturing techniques.

Further Details on the “Bean” Coolant Channel

This section discusses various features inherent to the use of bean shaped fluid channels within heat exchangers.

As background and as previously mentioned in part, fluid heat exchangers use coolant filled channels to transfer heat from a solid to the cooler fluid. Traditionally, the channels have been limited to rectangular and circular designs. While rectangular channels have heat transfer rates greater than those of circular channels, their corners are structural weak points due to stress concentrations. To avoid choosing between structural stability and efficient heat transfer, engineers have attempted to modify the rectangular geometry to achieve better structural traits without sacrificing heat transfer, but the results yielded little actual benefit.

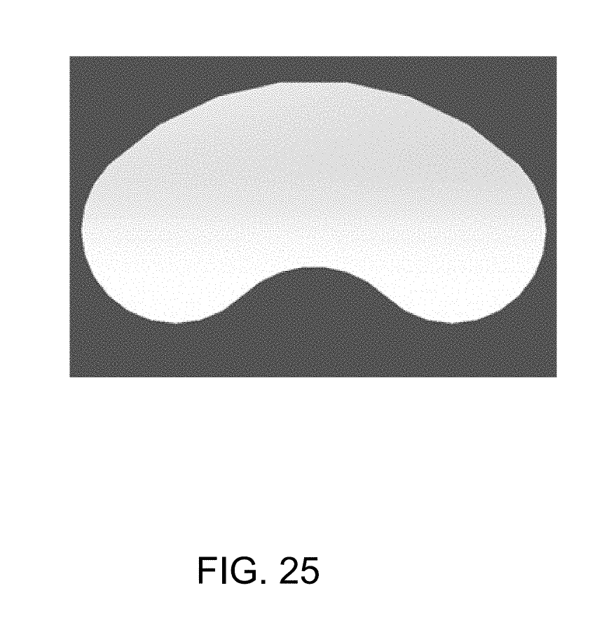

Through research and development, an enhanced channel cross section has been developed: the bean. Pictured in FIG. 25, the bean is shaped exactly as its name implies. The shape combines the structural curves of the circular channel with the high surface area of the rectangular channel to create a highly efficient and structurally sound heat transfer channel. FIG. 25 depicts an example of a cross-sectional area of a bean coolant channel.

In addition to combining the structural benefits of both traditional geometries, the bean shaped channel provides a more even heat transfer across the length of the wall. It lacks the extreme peaks and valleys in temperature inherent to the standard geometries. This even distribution reduces thermal stresses in the wall caused by large thermal gradients and non-uniform rates of thermal expansion.

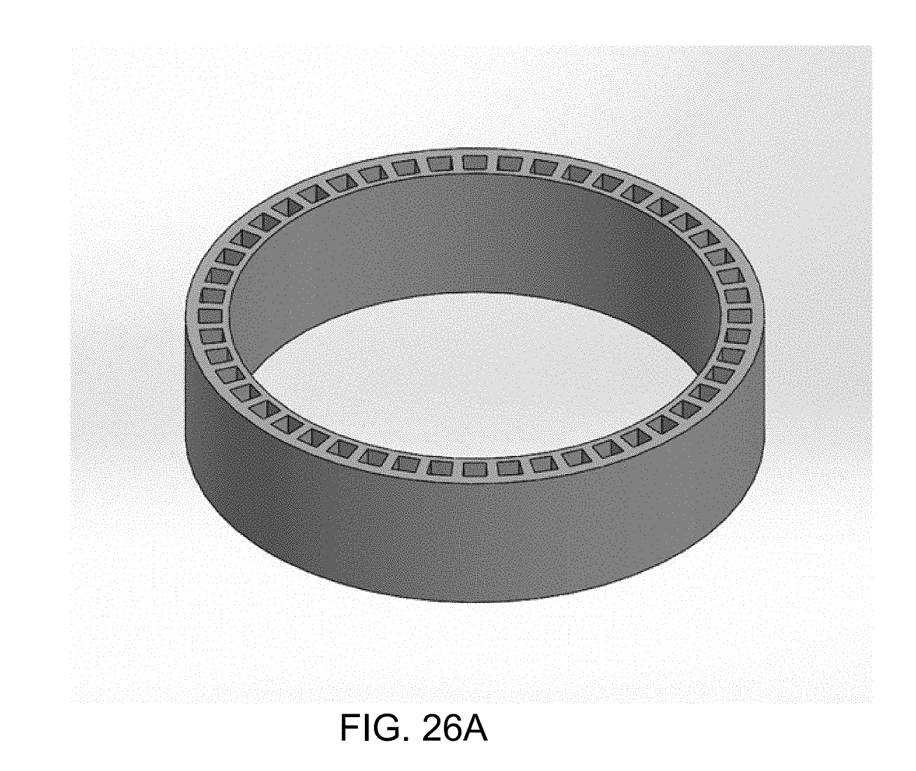

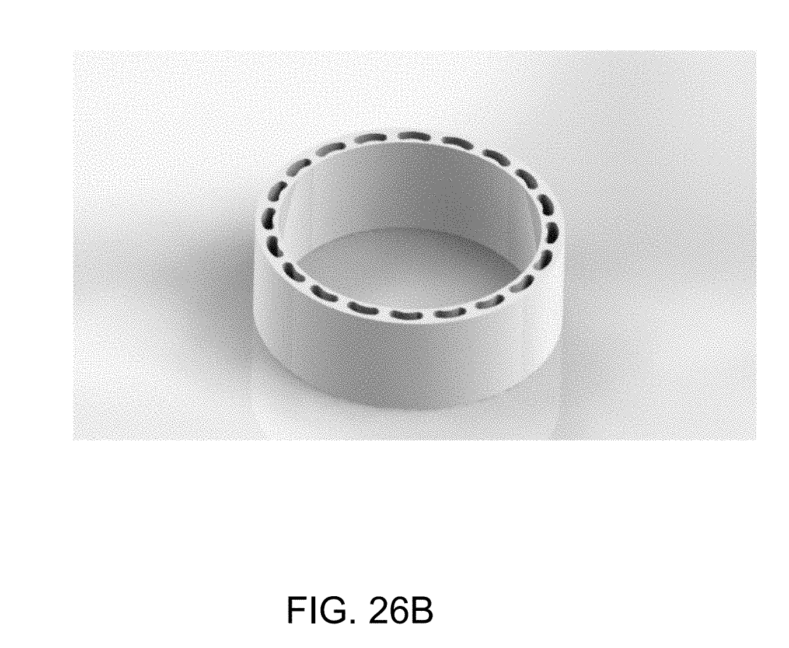

Simulations were conducted to compare the effectiveness of heat transfer between the rectangular, circular, and bean shaped channels. A cylinder with an annular cross section and cooling channels running along the length was modeled for each geometry. These channels were designed so that the individual channel cross sections, the total fluid domain area, and the minimum distance from the inner wall were near equal. The rectangular channel simulation geometry in FIG. 26A serves as a representative example for all three. FIG. 26A shows what the cylinder looks like with rectangular channels, while FIG. 26B shows an example of what the cylinder looks like with bean-shaped channels. It therefore can be similarly contemplated how the circular and other shaped channels would be positioned around the cylinder as well.

In one example set of simulations, ANSYS 17.1 was used to conduct steady state coupled fluid-heat transfer simulations to capture the heat transfer effects of both convection and conduction. Nickel was used for the solid, while liquid kerosene was used for the liquid. The inside wall of the geometry was set to 726° C., while the outside wall along with the top and bottom faces were modeled as insulated. The inlets were defined with a total mass flow rate 0.2 kg/s and a temperature of 27° C.

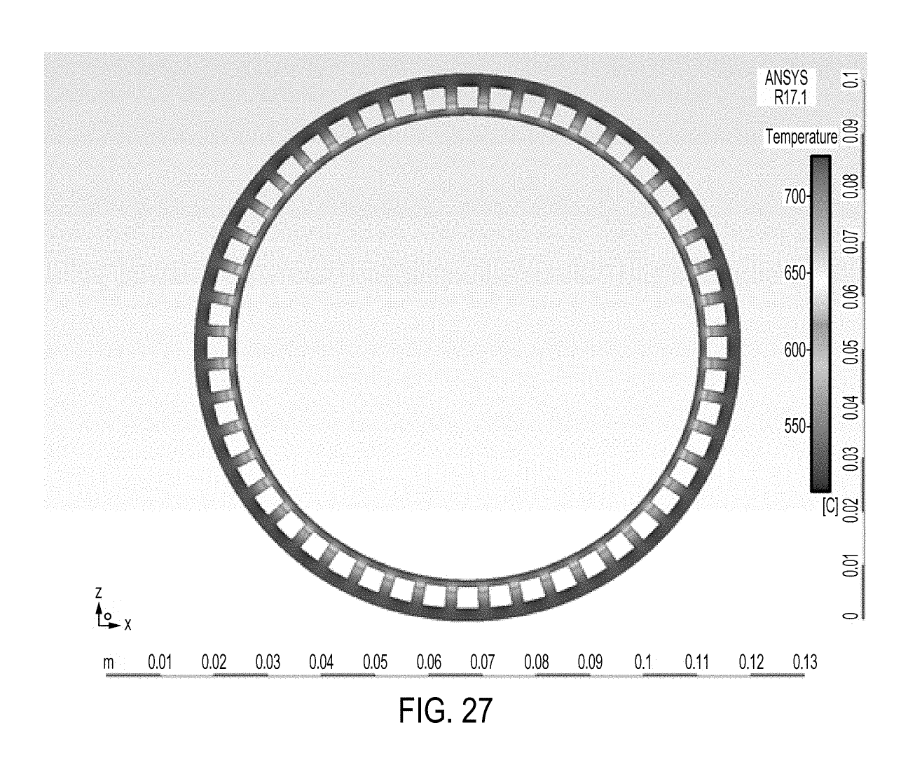

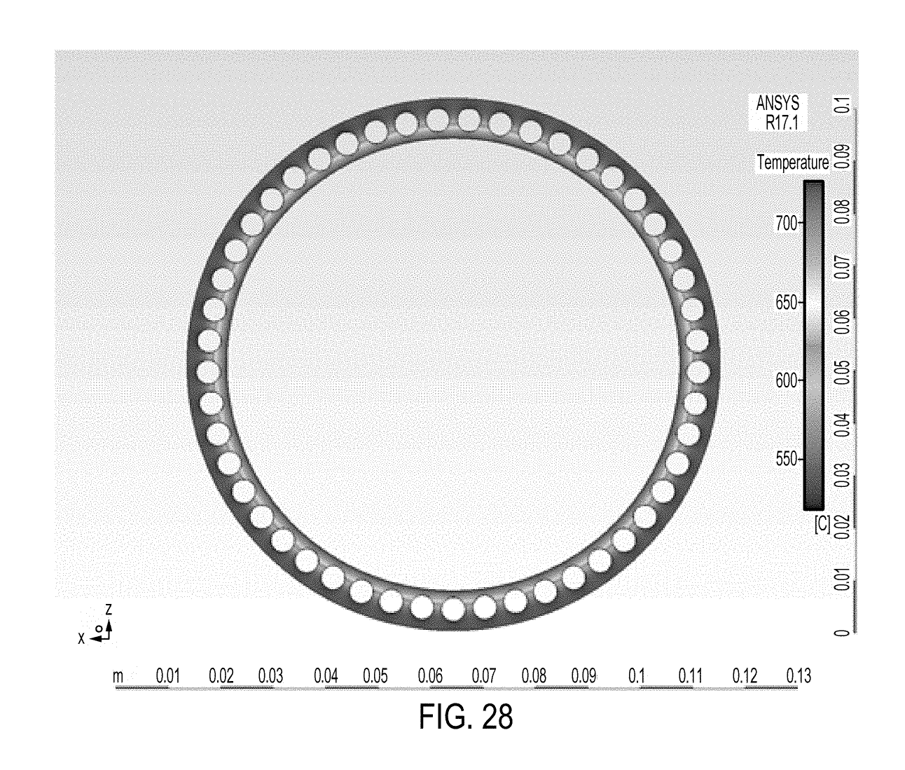

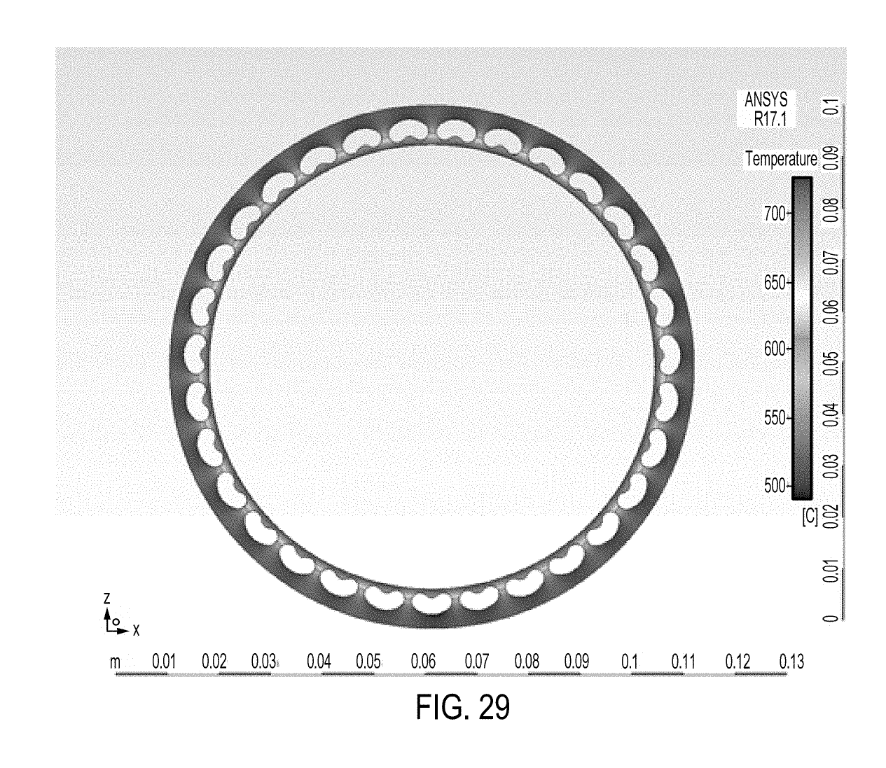

Thermal contours for the results of each geometry can be found in FIGS. 27, 28, and 29, for the rectangular cross sectional channel, the circular cross sectional channel, and the bean-shaped cross sectional channel, respectively. The thermal advantages of using rectangular cooling channels over circular ones can be seen through the lower temperatures, as well as less heat penetration through the wall. Table 1, below, confirms these visual indicators, as both the average and minimum temperature of the rectangular channels are lower when compared to those of the circular channels′. However, according to FIG. 29, the bean's increase in efficiency is clearly evident. The bean effectively cools the chamber compared to both geometries while maintaining the structurally advantageous curves of the circular geometry. Table 1 validates the bean's superiority with the lowest minimum and average temperatures at 490.28° C. and 561.36° C., respectively.

TABLE 1
Temperature results for the rectangular, circular, and bean channels

| | Minimum | Maximum | Average |
|---|---|---|---|
| | Temperature | Temperature | Temperature |
| Geometry | (° C.) | (° C.) | (° C.) |
| Rectangular | 507.14 | 726.21 | 584.85 |
| Circular | 518.71 | 726.23 | 600.29 |
| Bean | 490.28 | 726.41 | 561.36 |

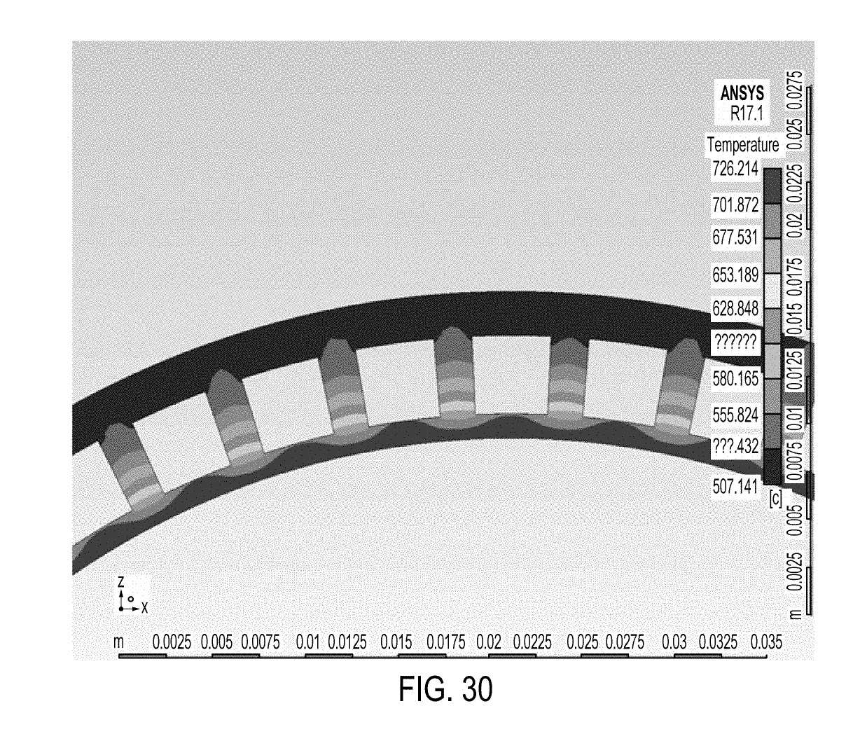

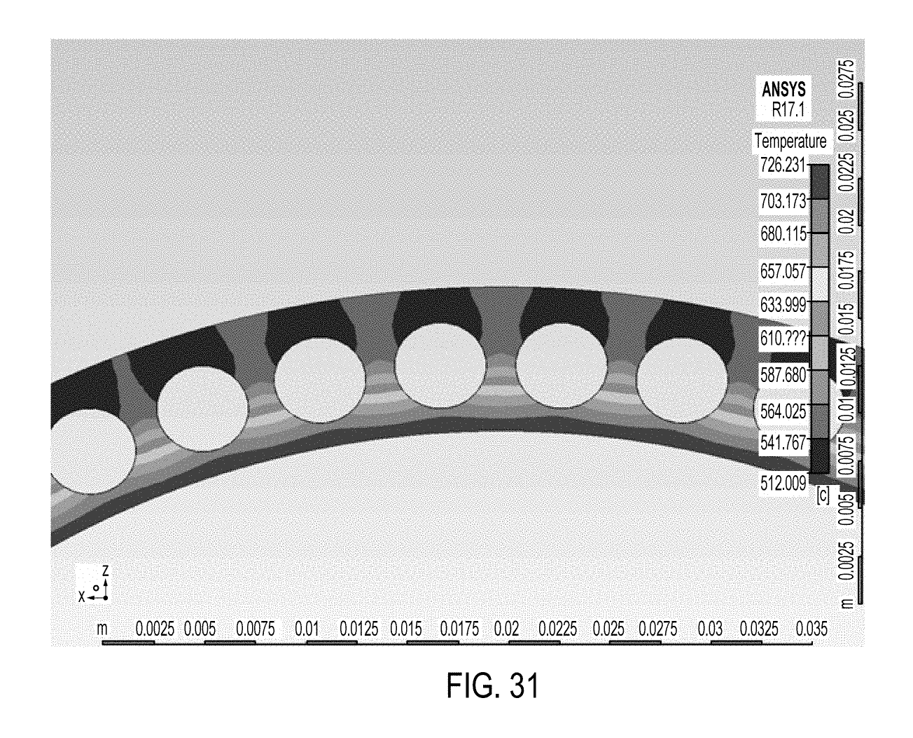

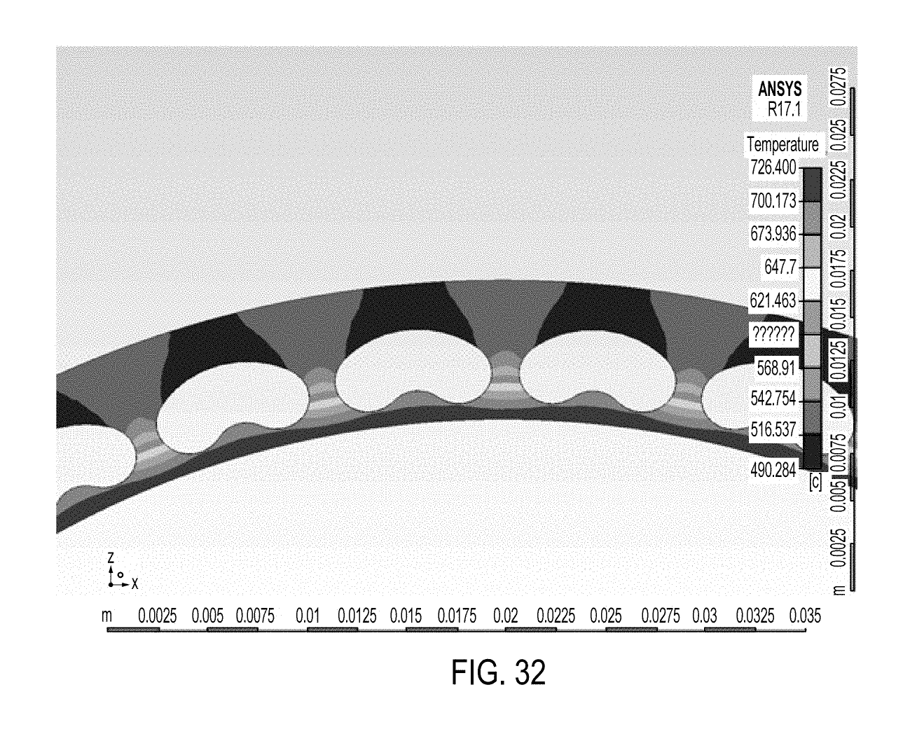

When the result visuals are magnified to accentuate the temperature banding, as seen in FIGS. 30, 31, and 32, for the rectangle, circle, and bean-shaped cross sectional channels, respectively, the even distribution of heat transfer in the bean channels is easily seen. The grayscale gradient shows more clearly the banded temperature contours of each of the different types of cross-sectional channels. While the rectangular channels may have an exceptional geometry in regard to heat transfer rate, they have incredibly uneven temperature gradients along their walls. The circular geometry improves upon this uneven heat transfer, but is subpar in its cooling. The bean shows itself to be more effective in both important metrics.

Recent advances in simulation and optimization software, combined with additive manufacturing, have allowed for the creation of optimized bean shaped fluid heat exchanger geometries. These bean shaped fluid channels combine the best of both rectangular and circular cooling channels. They have the superior heat exchanging ability of rectangular channels while maintaining the strength characteristics of the circular channels. In addition, this geometry also allows for the more even extraction of heat, which in turn helps reduce thermal stress within the wall being cooled. These characteristics enable the bean geometry to be far superior to the circular and rectangular designs of the past.

Additional Example Embodiments of Structural Heat Exchanger

Multiple Channel Implementation

In some embodiments, structural heat exchanger channels may be combined in a truss-like arrangement including trapezoidal or bean-shape channel cross sections, combined in a way to satisfy a particular set of advanced boundary conditions. This may include large pressure or heat fluctuations across a plate wherein the gas side wall may alternate from one face of the heat exchanger to the other. This embodiment is exceedingly practical for counter-current heat exchanger flows where alternating channels are fed by outgoing or returning coolant.

Flat Plate

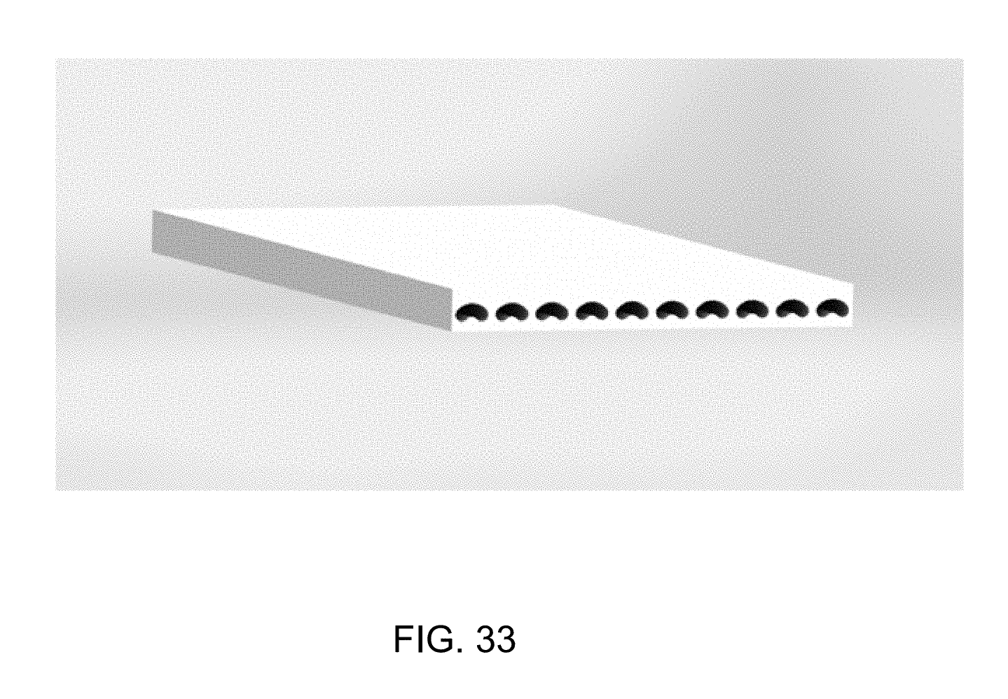

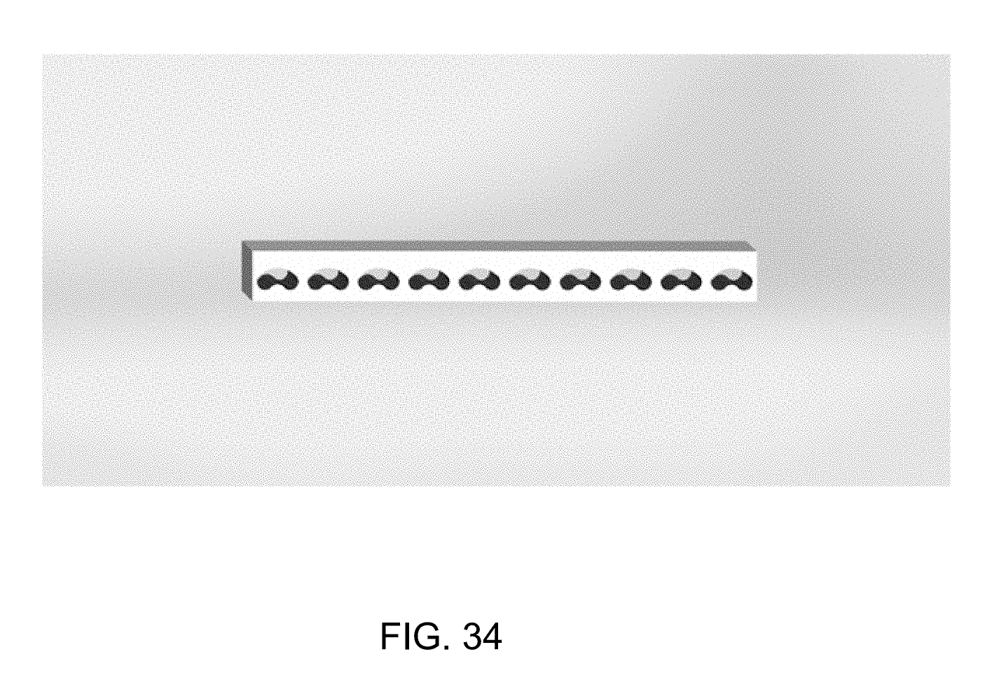

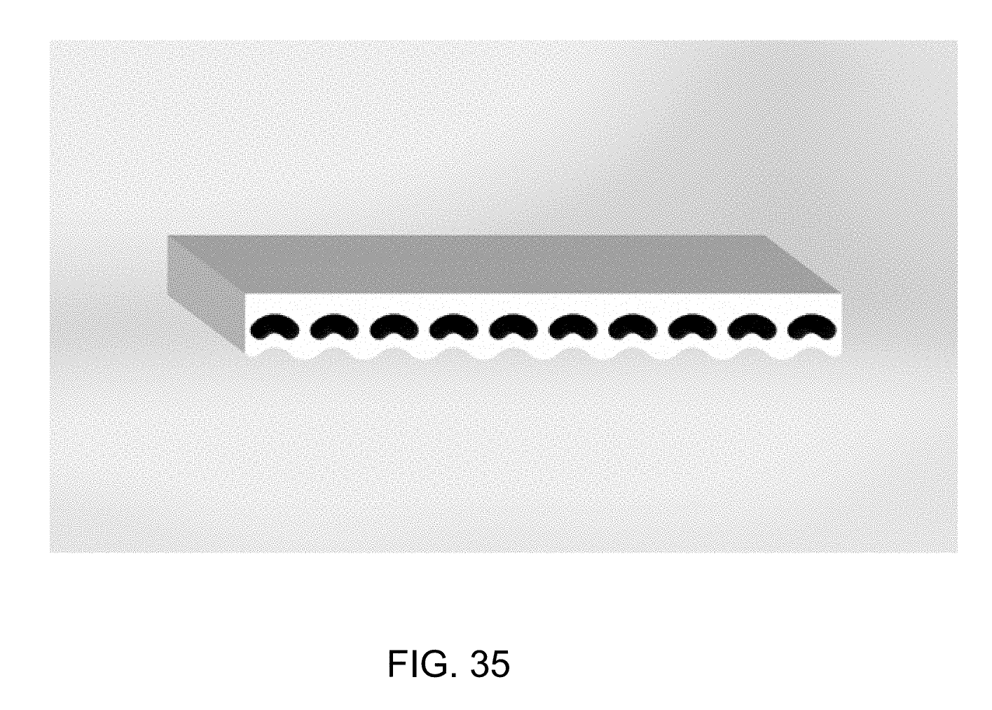

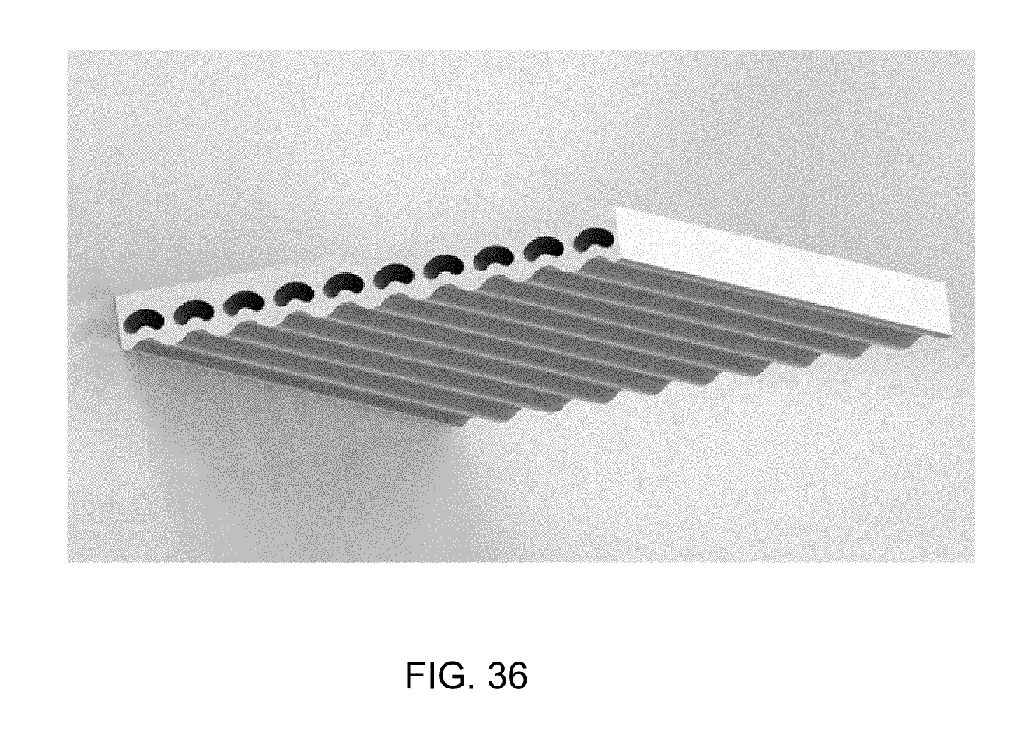

Bean channel heat pipes may be implemented into non-circular cross section geometries. These may include flat or curved plates as well as more complicated, predictably varying geometries. FIGS. 33 and 34 show an example of a flat plate from different angles having bean-shaped coolant channels, according to some embodiments. As another example, FIGS. 35 and 36 show a flat plate on the top surface with bean-shaped coolant channels, but with a wavy surface on the bottom that coincides with the concave geometry of the bean shapes. In this example embodiment, the thermal properties of the bottom surface allow for more uniform temperature loss along the bottom surface.

Nonuniform Heat

The structural heat exchanger can be easily implemented for thermal boundary conditions which change along the principal component of the coolant flow and channel direction. For thermal boundary conditions which are spatially and/or time varying in a direction primarily perpendicular to the major component of the coolant flow or channel direction, there must be additional treatment of the channel geometries. Channel sizing must be modified to increase flow velocity and therefore turbulence at the cost of pressure drop. This is accomplished by smoothly transitioning each heat exchanger channel to corresponding bean-like geometry with a reduced or increased cross sectional area to increase or decrease flow velocity corresponding to the peak thermal load present across the heat exchanger surface at a particular location. Alternatively, increased mass flow can be delivered to channels with spatially and/or time varying thermal loads.

Nonuniform Flow

In an ideal heat exchanger, coolant can be fed to uniform channels such that each channel has either identical mass flow, or a specific distribution of flow corresponding to the thermal loading. However, if an even and steady distribution of coolant across all channels is not possible, alterations to the channel geometries must be made to take this into account. These modifications may take the form of resized and/or reshaped bean channels corresponding to the heat flux and flow available.

### Example Industrial Applications

The following are descriptions of uses for various types of the heat exchanger of the present disclosure:

Gas generator turbo machinery: coolant channels may be embedded into cylindrical walls of a compressor or expander cycle (or within the blades themselves).

Power Generation Heat Exchanges: cylindrical structural heat exchanger with and without conforming internal surfaces are ideal for transporting heat from a working fluid into a moderating fluid (or coolant)

Automotive Engines: Cylindrical heat exchanger used within each combustion cylinder. The channels may have identical boundary conditions to an engine thruster. The fuel or coolant can be used to remove heat from the wall, enabling higher operating temperatures and reduced thermal losses.

HVAC unit: The flat plate may be used in HVAC systems as opposed to standard fin and pipe heat exchanger.

Server cooling: The bean cooling channels can be used in high performance computing environments to pull heat from a chip, instead of a combustion environment. The flat plate employing the coolant channels may also be used in this case.

Other examples of the structurally optimized heat exchangers of the present disclosures may also be applied in jet engines, tooling bits, mining bits, brake disk rotors, and injection molds.

Example Method of Generating Coolant Channels

This section discusses a computer-implemented method for generating and deriving the various cross-sectional areas of the coolant channels described herein. As previously mentioned, the structures housing the channels may be additively manufactured, meaning the structure may be constructed layer by layer using known additive manufactured techniques, like a 3D printer accessing a CAD file with all of the properties and specifications for where to place the solid material to form the structure with the channels. Developing that CAD file, for example, is a non-trivial task that a computer-implemented method of the present disclosure is able to develop. Furthermore, the method may gradually change the cross-sectional area of any and all channels, layer by layer, to form different shapes at different locations along the same channel (see e.g., FIGS. 22 and 23).

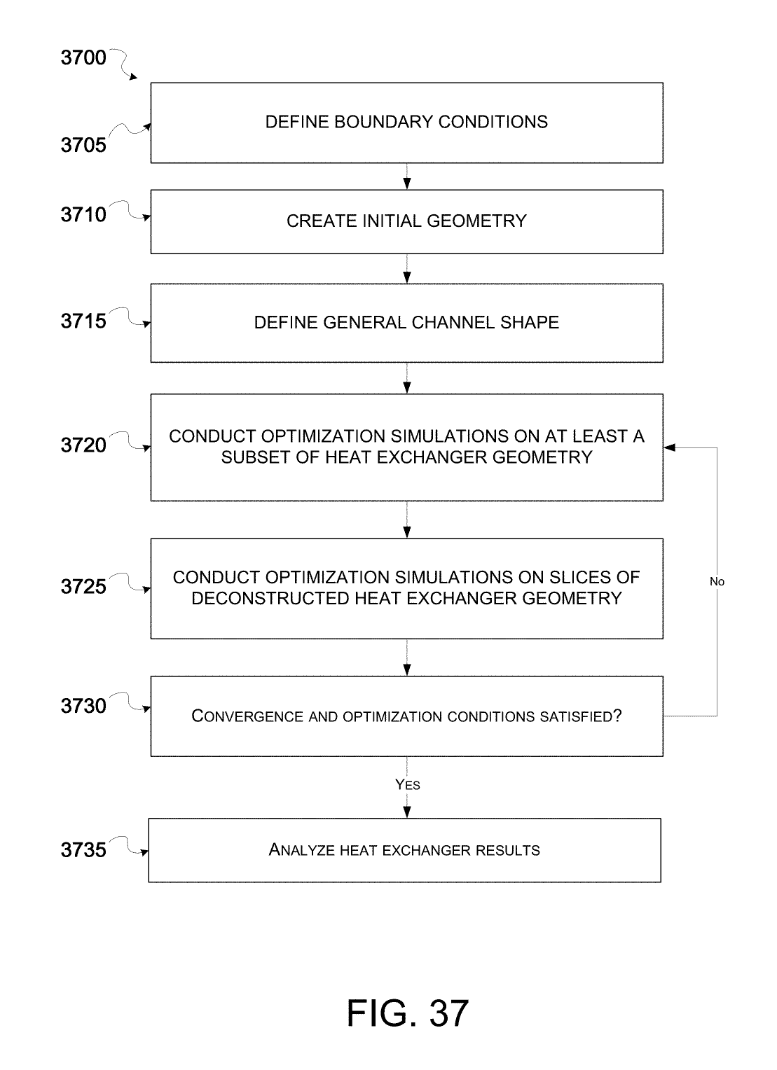

Referring to FIG. 37, flowchart 3700 provides an example methodology for developing a structural heat exchanger having any number of coolant channels, with any variety of cross-sectional shapes, built to satisfy varying needs of a variety of industrial applicabilities. In some cases, a computer-implemented method for designing a structural heat exchanger could be made by manually designing the shapes and structures. However, in order for a structural heat exchanger to be better suited to satisfy the cooling properties desired for a given use case, more precise engineering should be employed. Flowchart 3700 provides an example for how a computer goes about generating such a structural heat exchanger to satisfy the specified needs.

At block 3705, one or more boundary conditions are defined and accessed by a computer configured to implement the method, according to some embodiments. These inputs may be provided by human engineers who have computed the various needs, or who may be following specifications provided by other authorities. Various CAD or CAE (Computer Aided Engineering) tools may be used to calculate and then determine these boundary conditions. The boundary conditions can include any number of the following non-limiting examples:

Thermal: Heat Flux, Ambient/Initial Temperatures, Coolant Flow Rate, Surface Roughness, Radiative Heating/Cooling

Structural: Internal Pressure, Channel Pressure, External Pressure, Structural Loadings

Material Properties of Structure: Density, Tensile/Yield Strength, Fracture Toughness, Thermal Conductivity, Thermal Expansion, Thermal Diffusivity, Emissivity, Melting/Boiling Point, Built-In Internal Stresses, Heat Capacity, Specific Heat, Gain Morphology and Phase Change Information

Material Properties of Coolant: Density, Thermal Conductivity, Thermal Diffusivity, Emissivity, Melting/Boiling Point, Heat Capacity and Specific Heat

Material properties will vary in temperature and/or pressure. Not all properties listed are necessary. An accurate listing of these material properties, and others, varying over temperature and pressure will result in simulation results that are highly representative of the physical environment seen by the heat exchanger.

As an example, the structural heat exchanger boundary conditions which create an optimal environment for bean channel implementation include:

An interior (gas side wall) high heat flux condition;
A high heat capacity, low temperature coolant flowing rapidly through the channels while maintaining a liquid phase state;
A pressure condition Pcc>Pw>Po,

### Where:

Pcc: Pressure inside coolant channel;

Pw: Pressure seen by high heat flux wall;

Po: Ambient pressure at exterior of heat exchanger.

The computer utilized these boundary conditions and conducted the methodology described herein to derive the bean-shaped geometry that has proven to be a superior coolant channel.

In some embodiments, multiple sets of boundary conditions may be defined, each for different locations of the heat exchanger in order to meet different cooling needs at the various locations. For example, the boundary conditions at the throat of a converging diverging nozzle are substantially different than the wider portions away from the nozzle. The boundary conditions therefore can be made specific to different locations.

At block 3710, initial geometry of the structural heat exchanger housing the coolant channels may be created with the aides of CAD and CAE tools, according to some embodiments. This may be viewed as like an initial seed starting value, where an initial approximate guess as to what the best geometry might be can be inputted and received by the computer. A human developer may help create an initial geometry which roughly satisfies all boundary conditions. In some embodiments, the computer may provide suggestions using known solutions that it can verify roughly satisfy the boundary conditions to some threshold degree. A channel count and size may be selected, depending on the available coolant mass flow. This should be done to minimize boundary layers within cooling channels as well as prevent edge cases such as supersonic flow.

At block 3715, the general channel shape may be defined. Again, this may also be defined by a human engineer with the input received by the computer, or the computer may be configured to suggest a suitable shape, based on the initial boundary conditions. Again, this may be viewed as an initial seed starting value, where the initial approximate guess as to what the best shape should be can be provided in the computer. For example, the general bean channel shape may be defined, characterized by an inner and outer edge typically with differing radii of curvature and a curved portion connecting these edges on either side to form a closed channel.

At block 3720, with the initial parameters and objectives defined, the computer may now conduct one or more optimization simulations on at least a subset of the heat exchanger geometry. In some cases, this involves running coupled computational fluid dynamics and finite element analysis (CFD/FEA) simulations. The computer may simulate either a representative subset or the entire heat exchanger geometry in order to further define boundary conditions and determine the thermal loading of the fluid.

At block 3725, the computer may then conduct optimization simulations on slices of the deconstructed heat exchanger geometry. The whole geometry may be first decomposed into slices by the computer running the simulations. These slices may represent sets of layers created through additive manufacturing. For example, the slices may be horizontal layers of the heat exchanger shown in either FIG. 26A or 26B. The computer may then utilize macro boundary conditions from the previous step in block 3720 to run a geometric optimization of the internal channels and/or the wall structure they reside in. In other words, the optimization techniques may be isolated to smaller sections of the heat exchanger geometry. The coupled CFD/FEA simulations may be performed on each of the slices, according to some embodiments.

For example, in the case of the converging diverging nozzle (see e.g., FIG. 24), this is represented by changes to the inner and outer diameter of various slices rings. Given that the thermostructural characteristics of the optimized beans vary with the wall thickness and bean spacing, it is important to optimize each slice ring. Additionally, the layer by layer method follows the trajectory of the fluid and therefore is capable of taking the heating of the coolant (reduced thermal conductivity over distance) into account.

In the process of refining the shapes of the channels and the geometry overall, the computer may create a structure that changes the cross-sectional area of the coolant channels at various locations. For example, for areas that have lower need for cooling properties but have higher need for uniform mass flow, or that feed into other more uniform shapes, the heat exchanger may have channels whose cross-sectional area gradually changes from a bean shape to an oval shape.

Furthermore, the pitch angle of the coolant channels may be changed, to account for the boundary conditions. For example, as shown in FIG. 22, different sections of the single heat exchanger piece have parallel channels that change their pitch angle flowing upward, based on different cooling needs at the different locations. Surface area by the aggregate coolant channels is increased when the pitch angle is made steeper (more horizontal), which can thereby increase the heat transfer rate.

At block 3730, the computer may determine whether there is convergence and an optimization goal has been satisfied. If they have not, then the process may repeat, starting back at block 3720. Convergence may be achieved when the geometry and the channel shapes stop changing after the simulations are run and adjustments are made. The computer may optimize each slice repeatedly until one or more of the following optimization goals are met:

Matching with prescribed factor of safety criterion;
Low stress concentrations between channels;
Minimal divergence of thermal gradients along the inner wall representing thermal stresses; and
Symmetric channels given symmetric flow and thermal conditions.

At block 3735, assuming that the optimization goal has been met and convergence of the structure is achieved, the resulting heat exchanger is then analyzed. The analysis is performed to ensure, via testing or coupled system simulation that, performance criteria are met and operating conditions set. This helps ensure that the resulting cross sections are smoothly assembled and that all constituents as well as the geometry as a whole are manufacturable based on the feature-specific resolutions of the additive manufacturing device. In some cases, if this analysis reveals flaws, then repeat simulation optimization as necessary.

Embodiments Including Fractal Fluid Passages

In some embodiments, aspects of the present disclosure include branching fluid passages that reduce turbulent flow and generate evenly distributed fluid pressure as the fluids branch off into the different passages. In some embodiments, the branching passages may be subdivided into two sets: the branching passages for the liquid fuel and the branching passages for the liquid oxidizer. In some embodiments, the two sets of passages are carefully designed in an elegant yet extremely intricate manner that is optimized for proper fluid flow and maximal burn efficiency. The ends of all of the passages meet at the injector interface, which dispense the liquids into the combustion chamber for ignition. Generally, these designs are achieved through additive manufacturing, and would be extremely difficult, if not impossible, to be manufactured using traditional techniques.

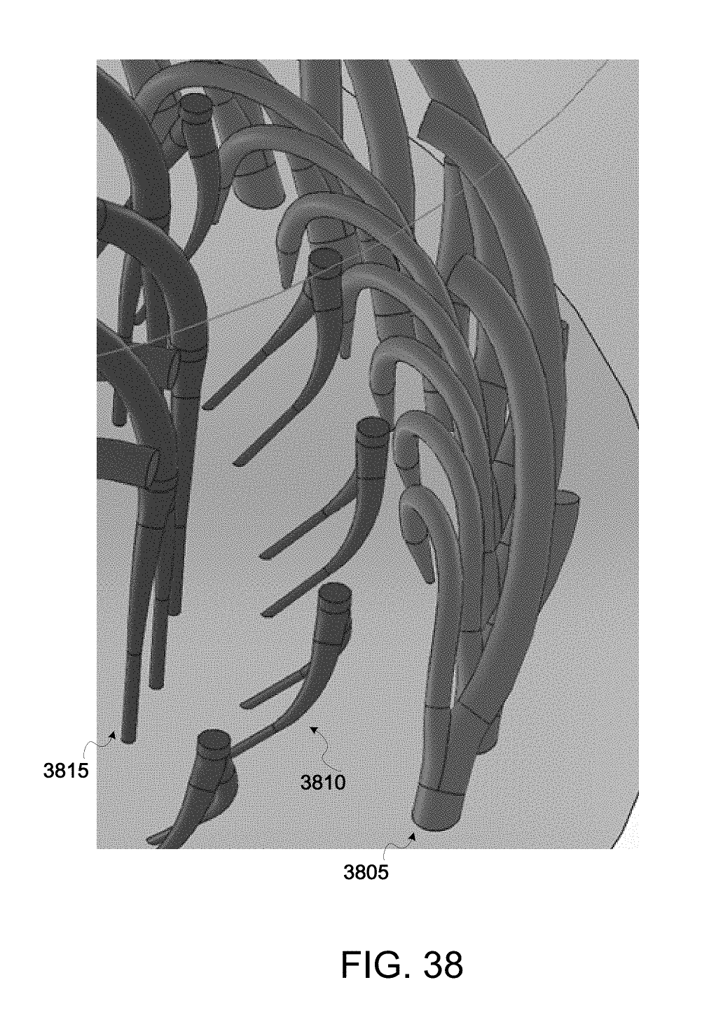

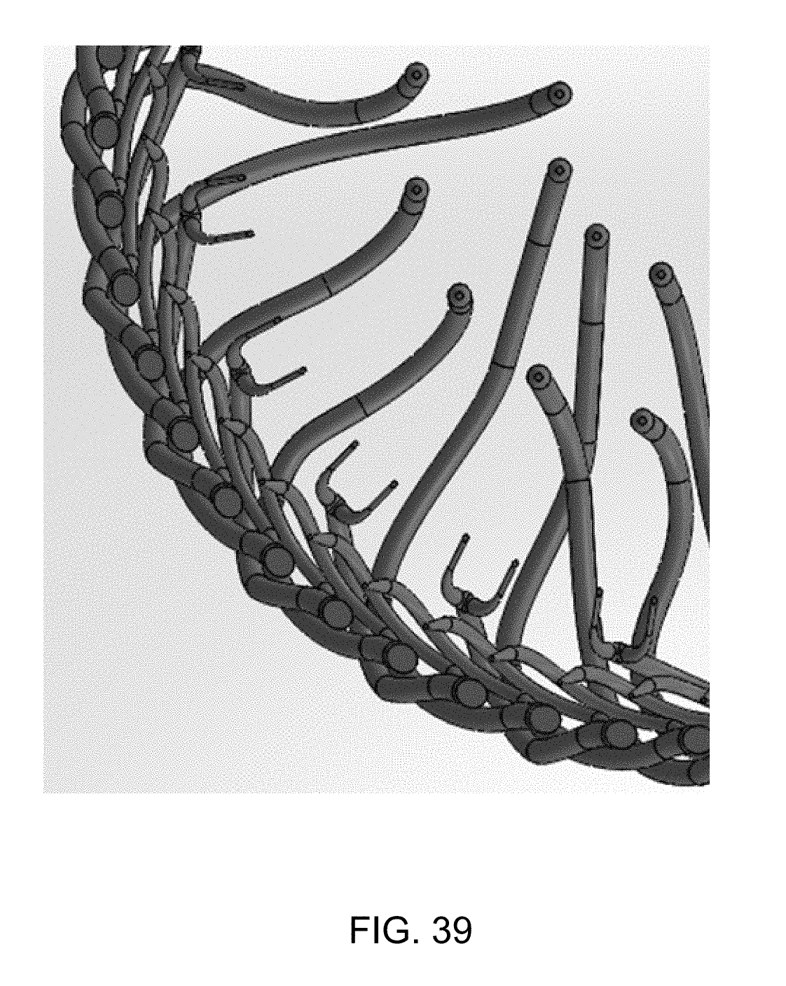

Referring to FIGS. 38 and 39, simulation schematics of portions of the fluid passages are shown, according to some embodiments. For example, shown in FIG. 38 are portions of the injector passages that flow from and connect to the ends of regenerative cooling channels. In some embodiments, the lighter shaded passages 3805 flow from and connect to the regenerative cooling channels that supply liquid fuel. The middle passages 3810 featuring branching pairs are portions of passages that connect to other passages of the regenerative cooling channels. The darker shaded passages 3815 flow down to supply liquid oxidizer, according to some embodiments. As shown in FIG. 38, some of the injector passages of the cooling channels 3805 branch off, flow up, and then curve quickly—though still smoothly—downward. These passages may be positioned to inject part of the liquid fuel toward the edges of the combustion chamber, to provide a cooling effect to the wall surfaces and act as a film/boundary layer for the wall surfaces. As shown, these orifices are angled inward, back toward the wall surfaces. These branches will be described in more detail, below.

Referring to FIG. 39, shown here are additional portions of the regenerative cooling channels that feed into the orifices of the injector interface. This view is from the perspective of looking up from the bottom of the passages. The longer tubes extended toward the center of the circular injector interface would connect to branching pairs or triplets of orifices, according to some embodiments. These will be described in more detail, below.

In general, and in some embodiments, branching passages fed by the regenerative cooling passages feed the fuel orifices of the injector. Each regenerative cooling passageway feeds one film/boundary layer cooling orifice and one or more injector elements orifices. Proper area ratios are maintained to ensure that the proper mass flows reach each orifice. Passage shape is smooth to reduce turbulent head loss. Passage trajectories deliver fuel to the orifices along the most efficient route while avoiding liquid oxygen passages. These passages are designed using novel design methods, according to some embodiments.

In some embodiments, the pressure drop through the RP-1 injector passages is minimal at ˜50 psi, as this comes from the acceleration of the flow. This occurs near the orifice exit where the passages converge to the orifice. A minimal pressure drop helps to reduce the total feed pressure required to drive fuel through the engine.

In some embodiments, pressure waves created from injector or combustion instabilities which attempt to propagate upward through the RP-1 passages will not affect the flow of other orifices in close proximity to produce feedback instabilities. The independently fed orifices prevent the interaction of pressure waves that would occur within a traditional manifold. In order for pressure waves propagating through one or more passages to interact, the waves must be very high in amplitude to pass through the regenerative cooling and into the diverter. If a wave should reach the diverter, the slight path length difference between the injector passages will yield out-of-phase pressure waves, which will interfere destructively.

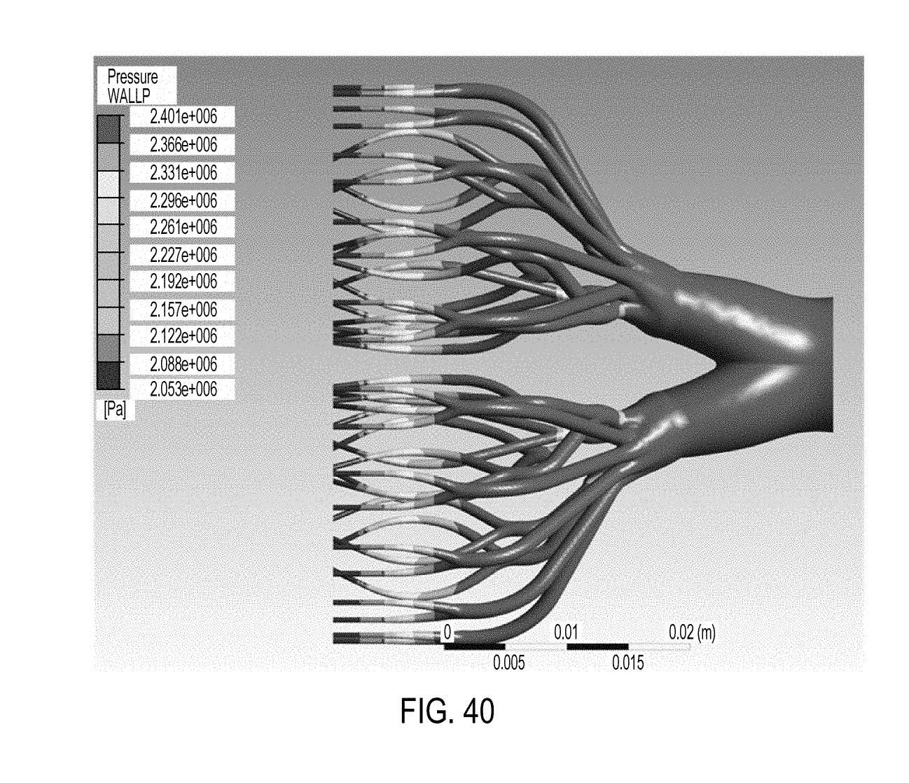

FIGS. 40-46 describe various aspects of the liquid oxidizer fractal fluid passages, according to some embodiments. Fractal branching fluid passages enable the transport of a fluid from a concentrated source to a larger surface area rapidly and without turbulent head loss. Branched fluid passages geometrically inhibit the propagation of potentially damaging combustion instabilities and pressure waves. Their structure possesses a high resonant frequency which prevents the resonance of undesirable waves which are typically present a much lower frequencies. Avoiding injector-combustion resonance is critical: for maintaining efficiency, ensuring that unstable waveform do not propagate upstream to tanks and other feed system components, where they may resonate, and for ensuring and ideal fuel/oxidizer mixture ratio and combustion efficiency over a wide range of throttling flows.

Shown in FIG. 40 is a side view of the main portions of fractal fluid passages to supply liquid oxidizer to the injector interface, according to some embodiments. According to the shaded key, the sizes of the passages are designed to provide a roughly equal amount of pressure drop in each passage at roughly the same distance from the injector interface, as shown by the shaded regions of the overall branching structure.

Branched passages maintain a relatively low fluid velocity while distributing fluid over an increased surface area. Fluid velocity is only permitted to increase at the passages final tier where the passages converge in order to accelerate the fluid through the orifice. Fractal branching mimics the biological distributions of fluids found in tree roots, cardiovascular and pulmonary systems, as well as being found in many other natural environments. Branched passages are capable of maintaining stability over a far greater range of initial and boundary conditions when compared to traditional fluid feed systems. These passages are designed to produce no turbulent pressure drop. Fractal passages are easily optimized for a variety of injector or fluid transmission schemes. They can be used to feed an arbitrary arrangement of fluid elements.

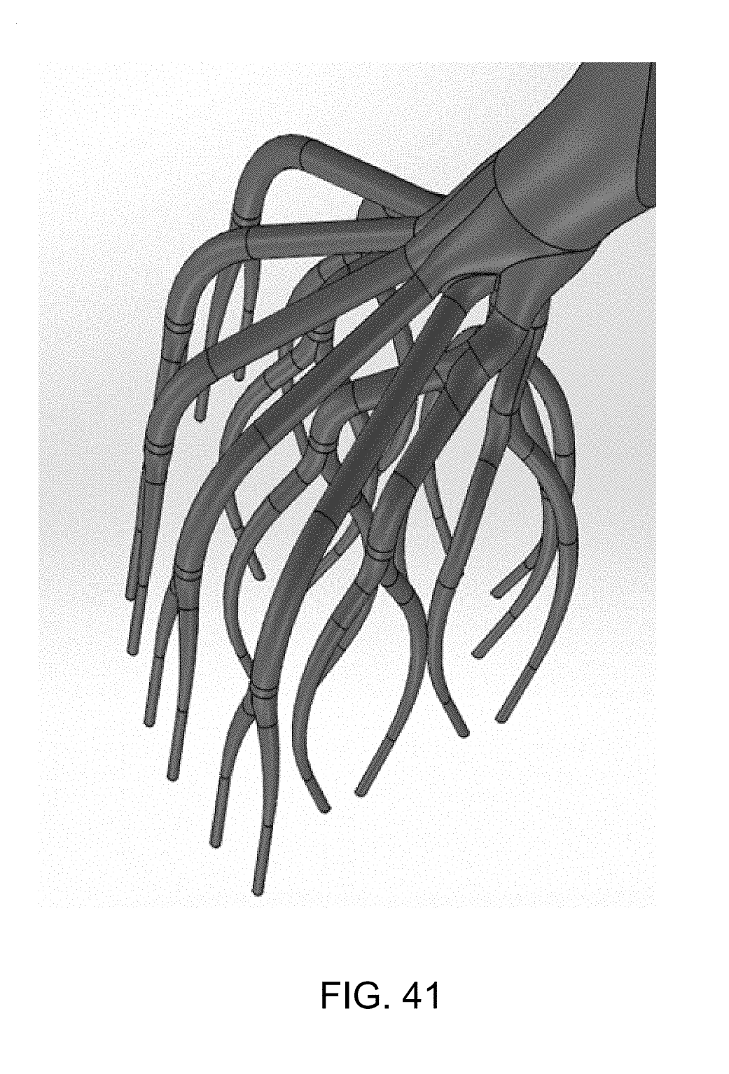

Referring to FIG. 41, a simulation rendering of a quarter armature of the liquid oxidizer passages is shown, according to some embodiments. It can be seen that the main branch divides itself into many multiple smaller branches, and from there, the smaller branches further subdivide one more time. The placement of the angles and subdivisions are purposely designed so as to reach the designated orifice position along the injector interface while providing even pressure drop, minimal turbulent flow and high pressure wave resistance. These constraints result in the branching patterns as shown, according to some embodiments.

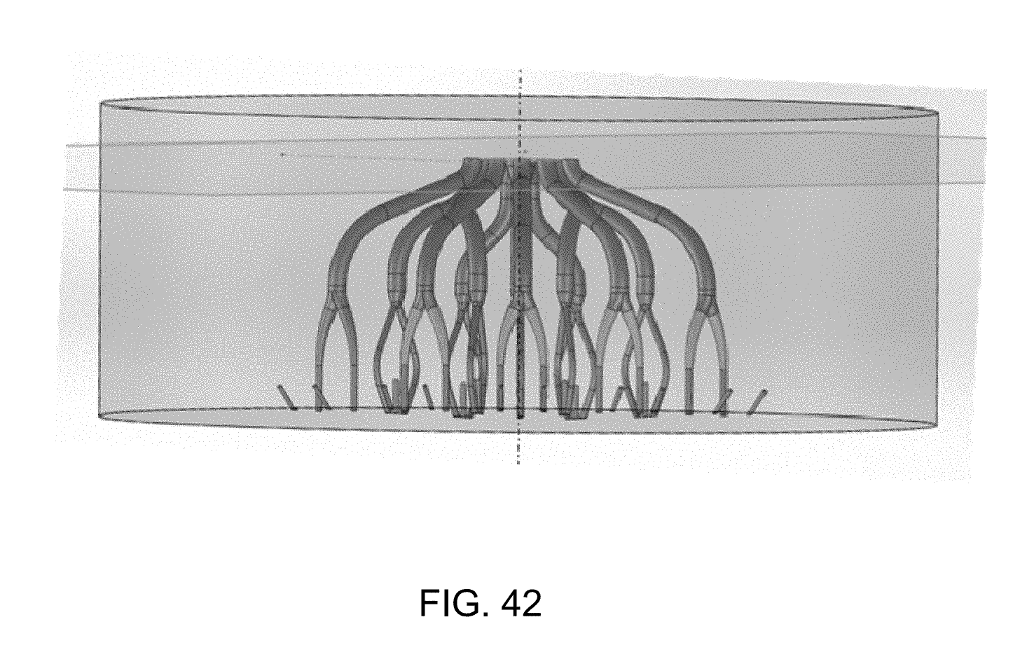

FIG. 42 shows another example fluid passage design for the liquid oxidizer, according to some embodiments. Also shown are the end portions of the fuel orifices, placed at the injector interface at more acute angles. These will be discussed in more detail, below.

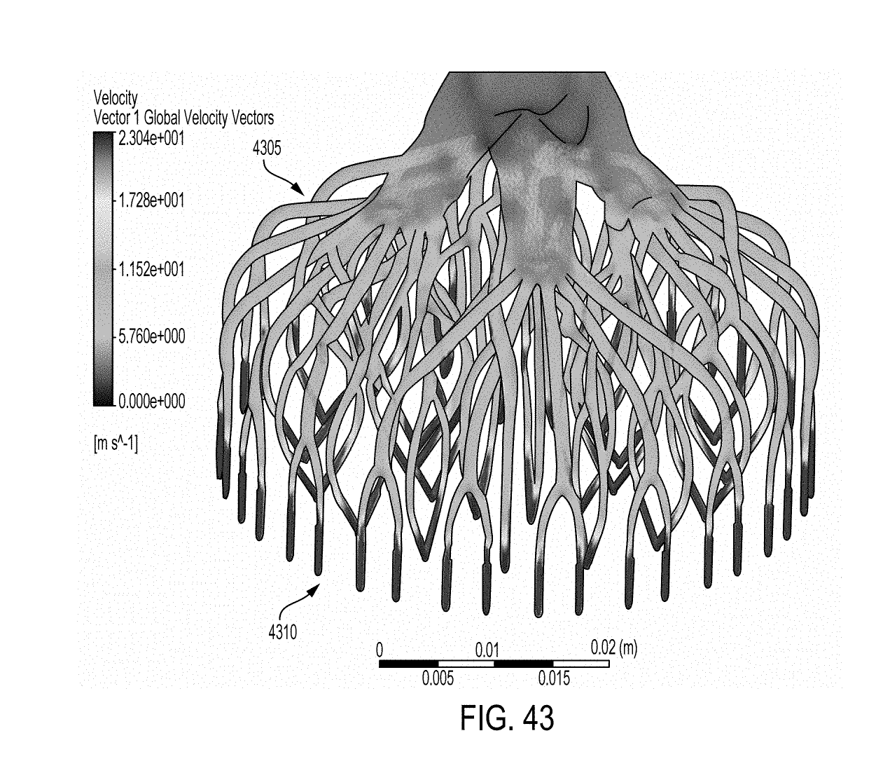

FIG. 43 shows a schematic of the liquid oxidizer fluid passages shaded according to fluid velocity, according to some embodiments. As shown, most of the passages maintain a relatively constant and low velocity throughout, according to the lighter shaded regions 4305 that correspond to the lighter shaded portion of the key, showing velocity of the liquid. The bottom portions of the passages 4310 show a darker shade, corresponding to a higher velocity as described in the upper range of the key. As shown, the higher velocity portions are consistently only at the bottom ends of each of the passages, which is to help ensure ejection of the liquid through the injector orifices.

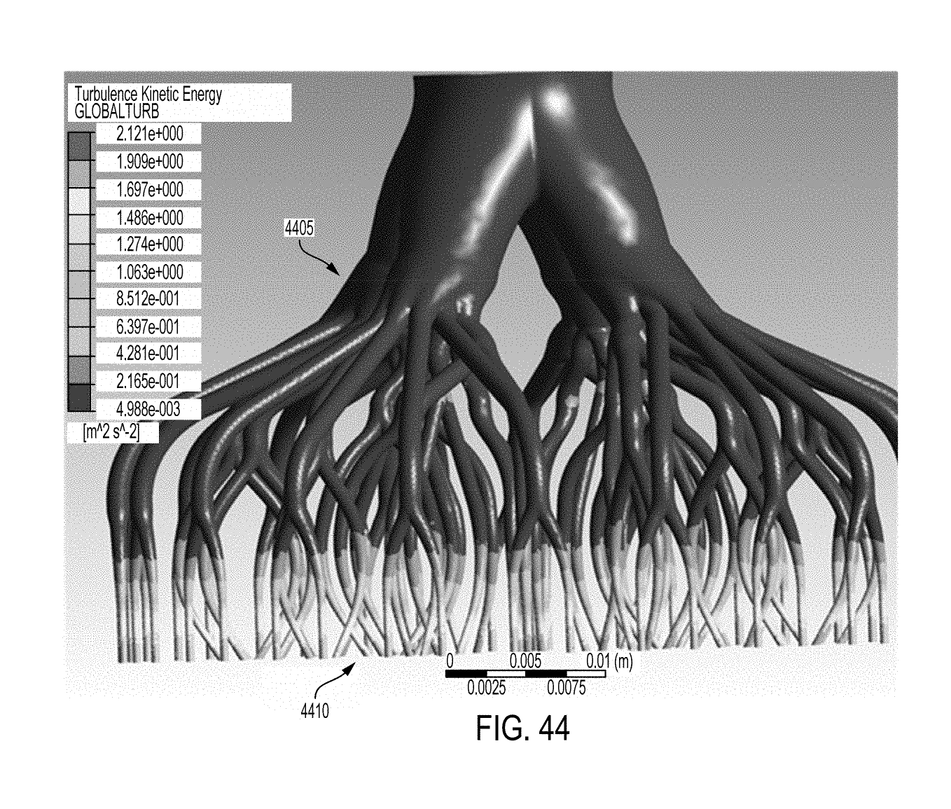

FIG. 44 shows a schematic of the liquid oxidizer fluid passages shaded according to turbulent kinetic energy, according to some embodiments. As shown, most of the passages maintain a relatively constant and low turbulence throughout, according to the darkest shaded regions 4405 that correspond to the darkest shaded portion at the bottom of the key, showing turbulence kinetic energy. It is only at the bottom portions of the passages 4410 where the turbulence increases, corresponding to a higher velocity as described in the upper range of the key.

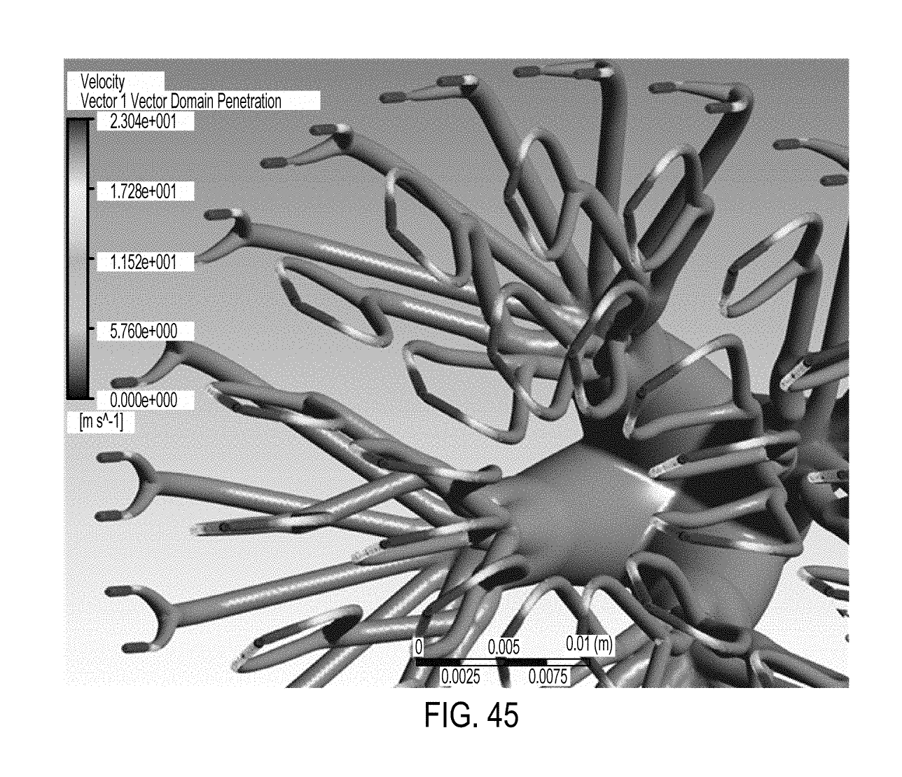

FIG. 45 shows a schematic of a different angle of the liquid oxidizer fluid passages shaded according to fluid velocity, according to some embodiments. This view shows how the orifices are angled in specific and varied directions. As shown, most of the passages maintain a relatively constant and low velocity throughout. The bottom ends (orifices) of the passages show the darkest shade, corresponding to a higher velocity as described in the upper range of the key. As shown, the higher velocity portions are consistently only at the bottom ends of each of the passages, which is to help ensure ejection of the liquid through the injector orifices.

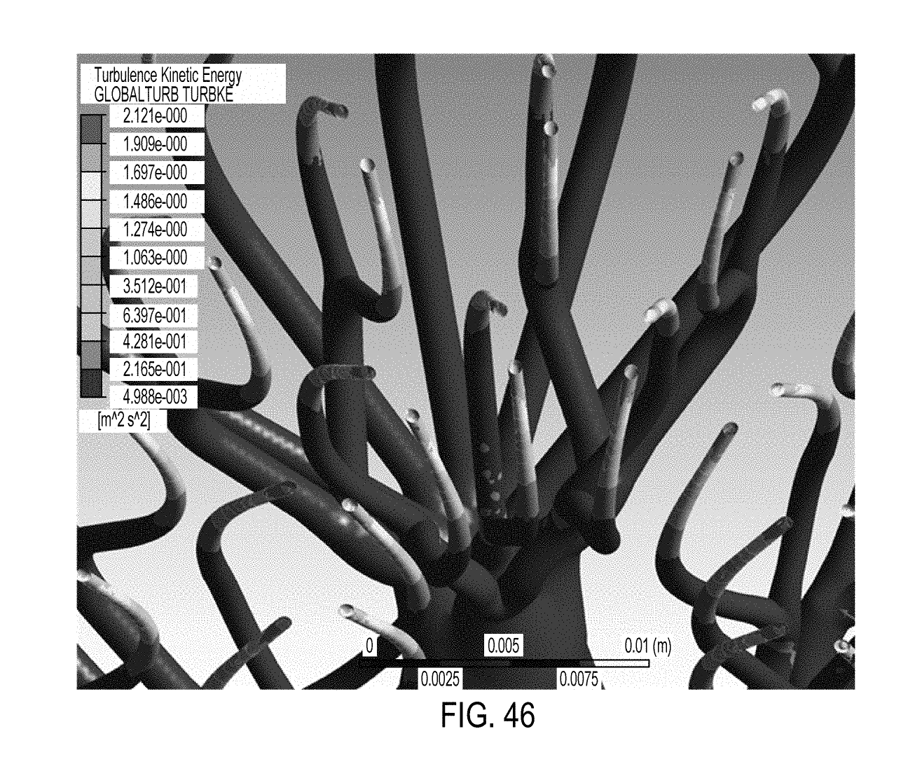

FIG. 46 shows a schematic of a different angle of the liquid oxidizer fluid passages shaded according to turbulent kinetic energy, according to some embodiments. This view shows an upside down angle of the orifices. As shown, most of the passages maintain a relatively constant and low turbulence throughout, according to the darkest shaded regions that correspond to the darkest shaded portion at the bottom of the key. It is only at the ends of the passages (orifices) where the turbulence increases, corresponding to a higher velocity as described in the upper range of the key.

The descriptions in FIGS. 43-46 provide evidence of an extremely stable system of passages. The high stability of these passages makes them well suited for: quenching combustion instabilities or other unstable fluid-transmissive waves, reacting flows high pressure and high flow situations, as well as environments where stable outflows are required despite intermittent or turbulent initial and boundary conditions.

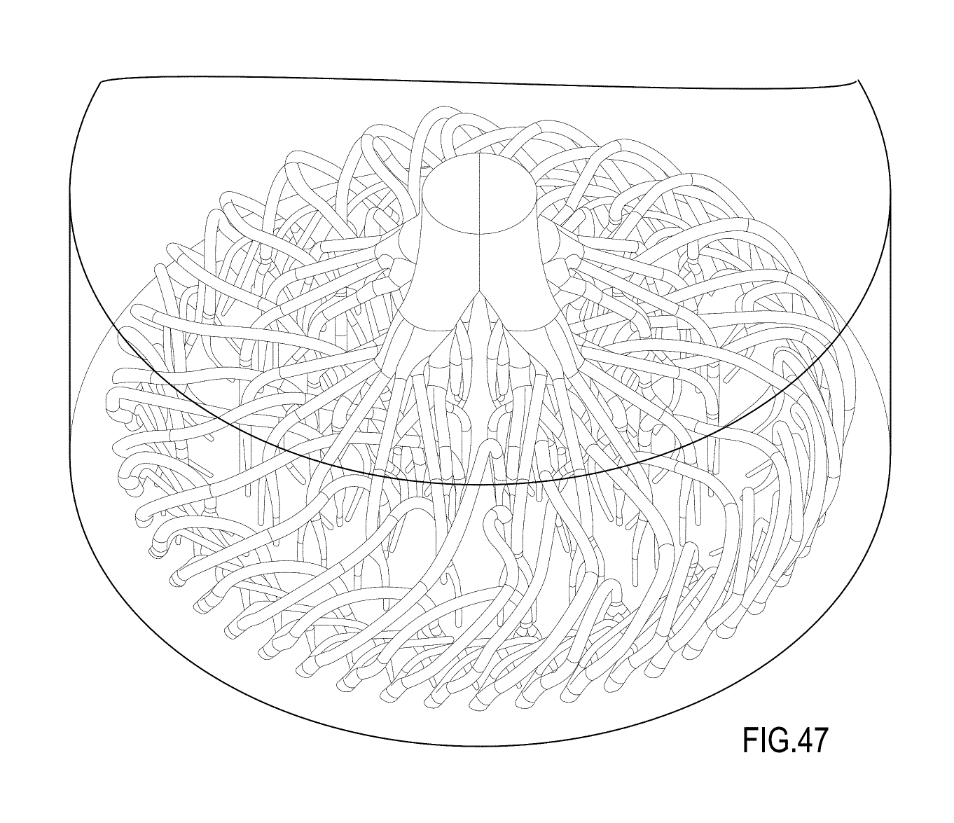

FIGS. 47-50 describe the combined system of passages of the liquid fuel and liquid oxidizer and how they intermingle into the injector interface. Referring to FIG. 47, shown is a schematic combining both sets of the liquid fuel passages and the liquid oxidizer passages into the injector interface, according to some embodiments. The outer ring of passages is the extension of the liquid fuel passages connected to the cooling channels that flow up the walls of the combustion chamber. As shown and previously described, a portion of the passages quickly turn down and inject the fuel on the edges of the inner chamber wall surfaces, to act as coolant. Also shown, other portions of these passages extend into various positions toward the center, intermingling with the passages of the liquid oxidizer, which is positioned in the center and shows an opening at the top that connects to the liquid oxidizer tank. It can be observed how intricate the formations of the passages are, all the while providing smooth, continuous flow that is highly stable.

In some embodiments, due to the cryogenic nature of the liquid oxidizer (LOX), minimizing the inlet to orifice passage length is prioritized. As a result, the fuel passages may be designed to accommodate this optimization. The minimum spacing between passages may be determined by the resolution of the apparatus used to create these passages using additive manufacturing, e.g., resolution of the 3D printer.

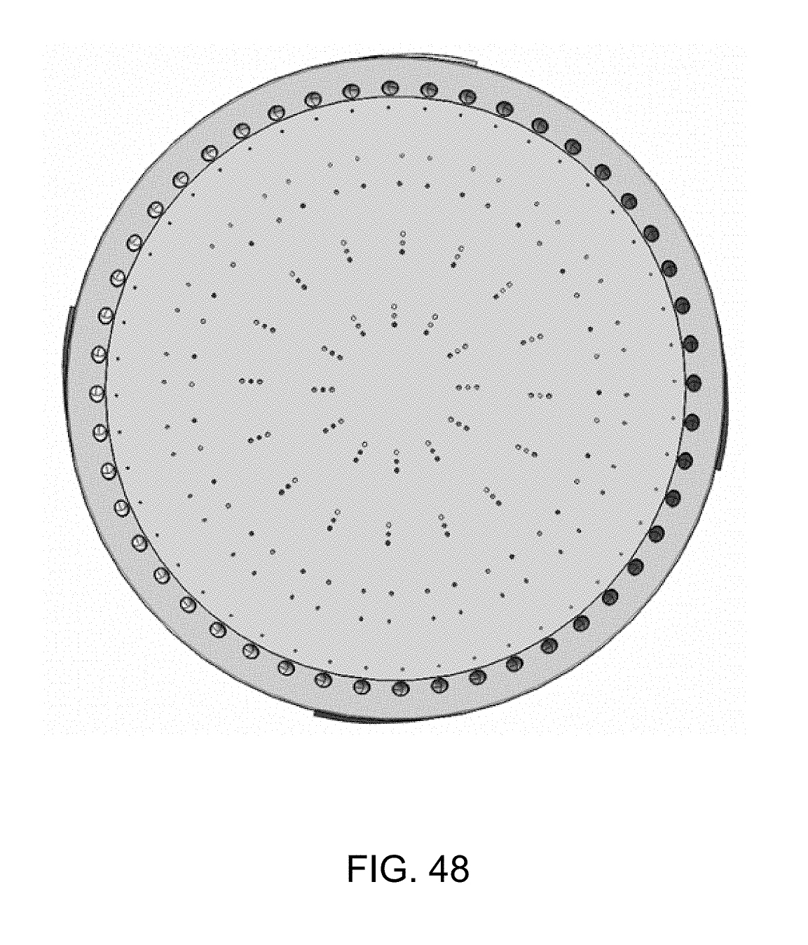

FIG. 48 shows the opposite side of the injector interface, showing the ultimate arrangement for how the orifices are positioned to inject liquid into the combustion chamber, according to some embodiments. The orifices of both the LOX and the liquid fuel may intermingle to be grouped into sets of triplets or quadlets. Each triplet or quadlet is defined as an element. The element pattern's primary role is to efficiently distribute and atomize fuel in the rocket engine. In order to accomplish the efficient mass flow distribution, a large number of orifices are required. FIG. 48 shows one example of an element pattern, though other patterns are possible and are within the scope of the present disclosures. The element pattern consists of three different types of elements: triplets, quadlets, and shower heads.

Triplets contain three orifices; two LOX and one liquid fuel (e.g., RP-1) in an oxidizer-fuel-oxidizer (OFO) pattern. In some embodiments, OFO is chosen because it provides a symmetrical element with no need to worry about varying momentum. In some embodiments, the triplets have an injection angle of 30° between oxidizer and fuel. The 30° provides enough of an intersection between fuel and oxidizer while still keeping the injection stream with a majority down chamber flow path. The triplet is selected for the center and majority of the injector plate because it provides steady, efficient combustion. This is due to the optimal mixture ratio of LOX/RP-1 being 2.56. This means that the orifices of the LOX and RP-1 are very similar in cross sectional area, resulting in efficient atomization because of similar particle size.

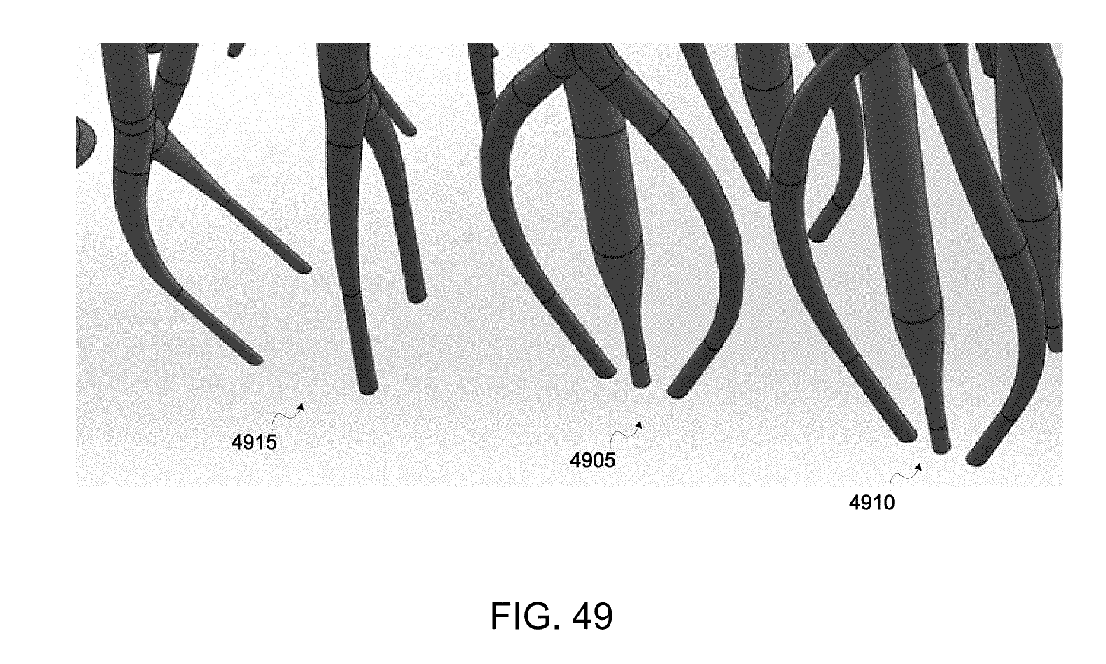

In some embodiments, the quadlet is selected for the exterior areas in order to provide a fuel rich ring of combustion. The quadlet contains more RP-1 than the triplets resulting in a fuel rich flame. This creates a lower temperature profile near the walls to reduce melting. FIG. 49 shows a close up view of two triplet elements 4905 and 4910 and one quadlet element 4915.

Referring back to FIG. 48, the orifices arranged in a ring closest to the chamber wall may be defined as a showerhead element. The showerhead is comprised of individual fuel orifices. These are angled toward the wall and provide a layer of protection against the high temperatures of combustion. The fuel is assumed to not combust with the absence of an oxidizer. Once the liquid fuel has evaporated, it provides a supersonic layer of gas fuel. This element is consistent with the descriptions in the previous figures re how a portion of the liquid fuel is injected purposefully toward the edges of the combustion chamber and onto the wall surface.

Combustion instabilities are one of the main issues for injector plates. In order to maximize combustion efficiency, orifices are selected to be as small as possible. However, these small orifices result in large amounts of combustion instability. Traditionally, large baffles are used to stop resonating. However, the selection of three different types of elements helps to mitigate these combustion instabilities. Each element creates oscillations at a different frequency. By utilizing multiple elements the combustion instabilities are for all intents and purposes a non-issue. Therefore, baffles are not required.

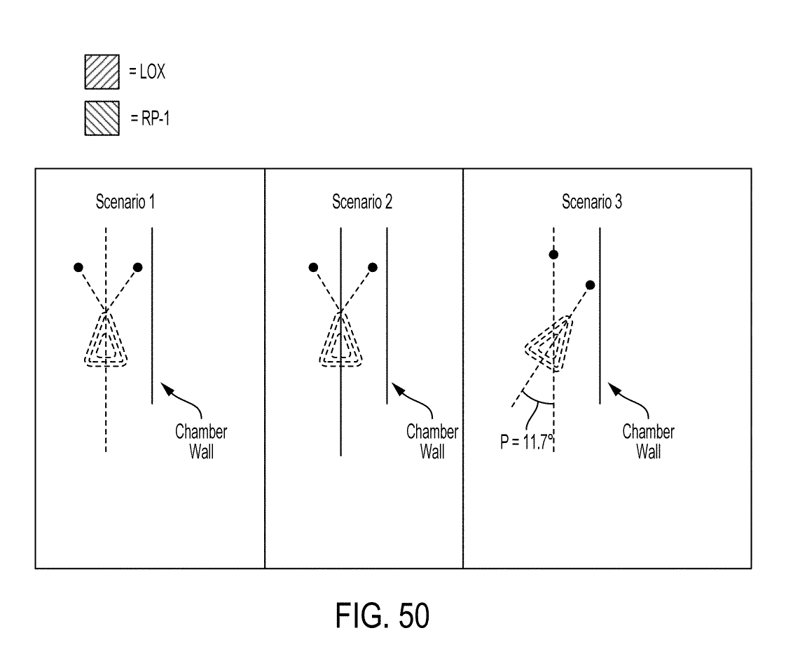

The injector contains a unique radially outward fuel rich gradient that helps to minimize wall melting and failure. This lowers the adiabatic flame temperature which inherently results in a lower temperature wall. Furthermore, because LOX creates a high temperature flame, it is important to note that the LOX orifices are located radially inward in the quadlets. This ensures that the walls are only being exposed to either fuel film cooling, or fuel rich flame. FIG. 50 shows three different scenarios for choices of arranging which type of liquid at which type of angle in the quadlet. Scenario 3 has been reasoned to be a more favorable arrangement, due to the closest orifice injecting liquid away from the chamber wall so as to reduce heat at the wall surface.

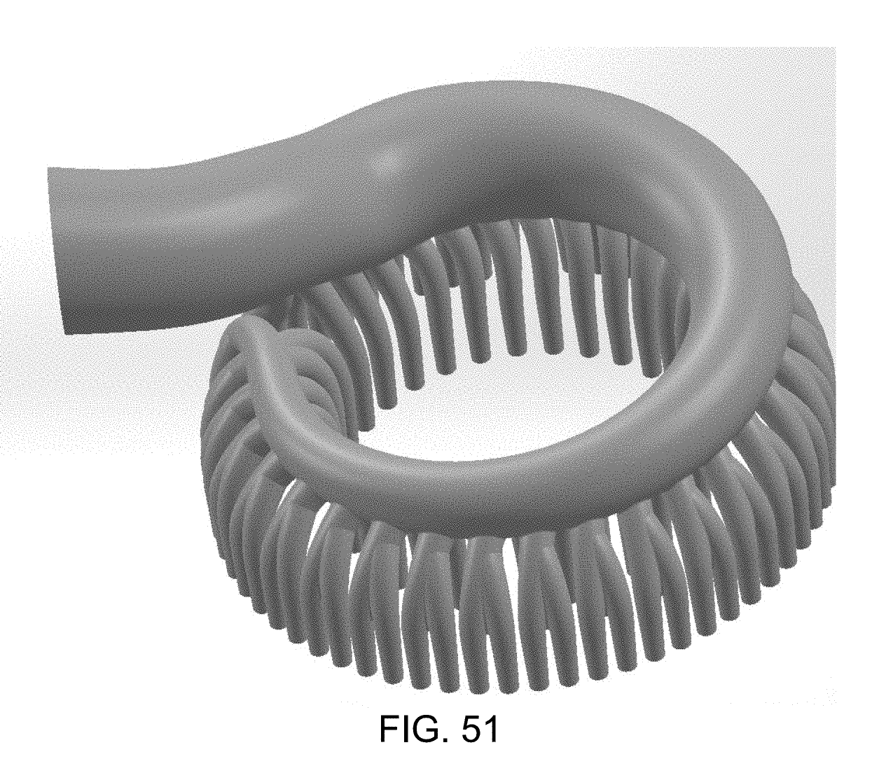

Referring to FIGS. 51-55, in some embodiments, a decreasing annulus fluid diverter may be employed to be included as part of the design for the fractal fluid passages leading to the injector orifices. General descriptions of a decreasing annulus fluid diverter are discussed in FIGS. 9-13 and related descriptions, above. The general concepts of that fluid diverter may be applied to feed the branching passages into the injector interface. A perspective view of an example of such a design is shown in FIG. 51. Here, the liquid oxidizer may be delivered initially through the large portion of the passage on the top left. Multiple fractal passages may connect to the diverter in series. The main channel may be arranged in a circular fashion, although in other cases this is not the case. As each of the fractal passages divert some of the fluid away from the main passage, the radius of the diverter progressively decreases, in proportion that compensates for the anticipated pressure drop due to the diverted fluid. In this way, the pressure drop throughout the diverter remains constant.

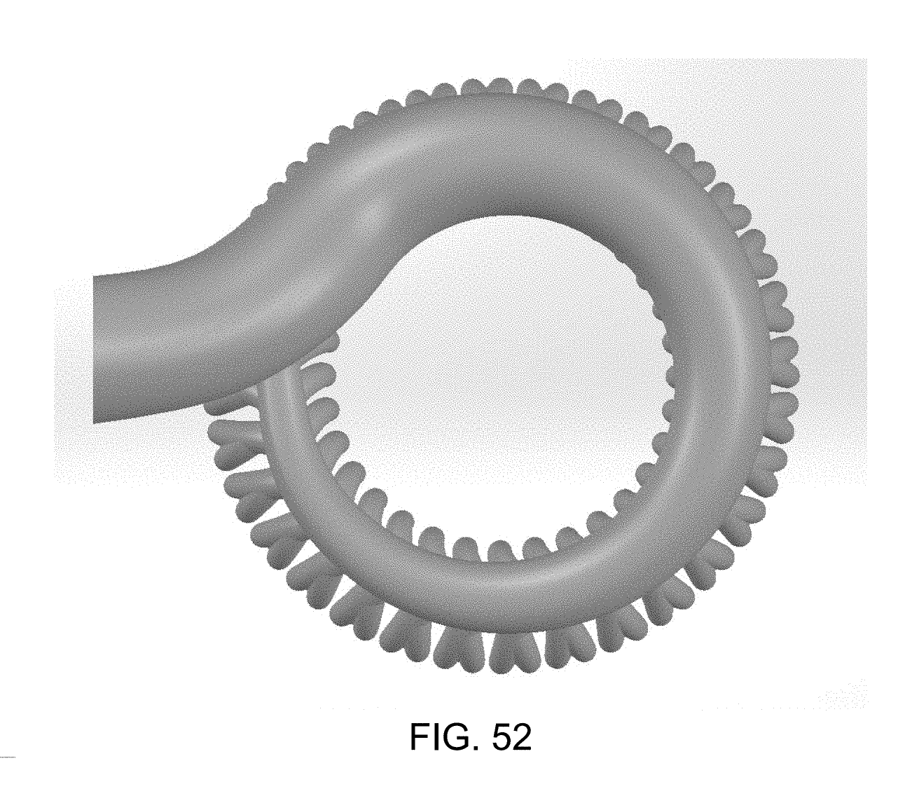

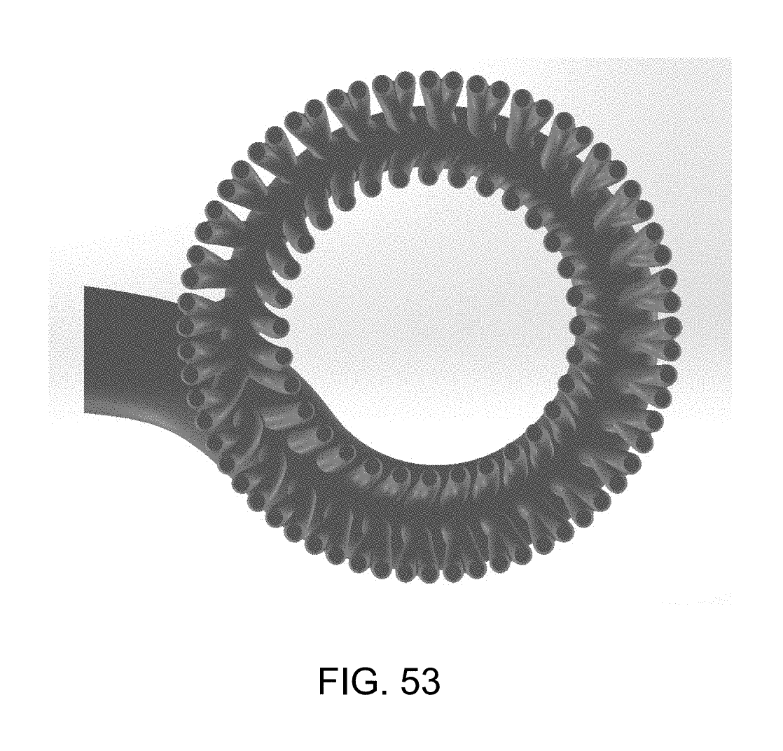

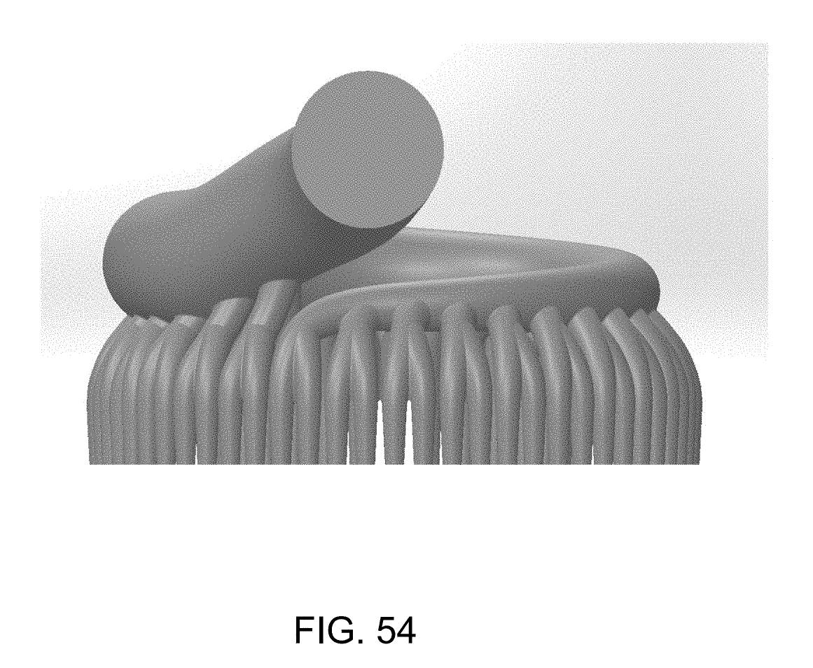

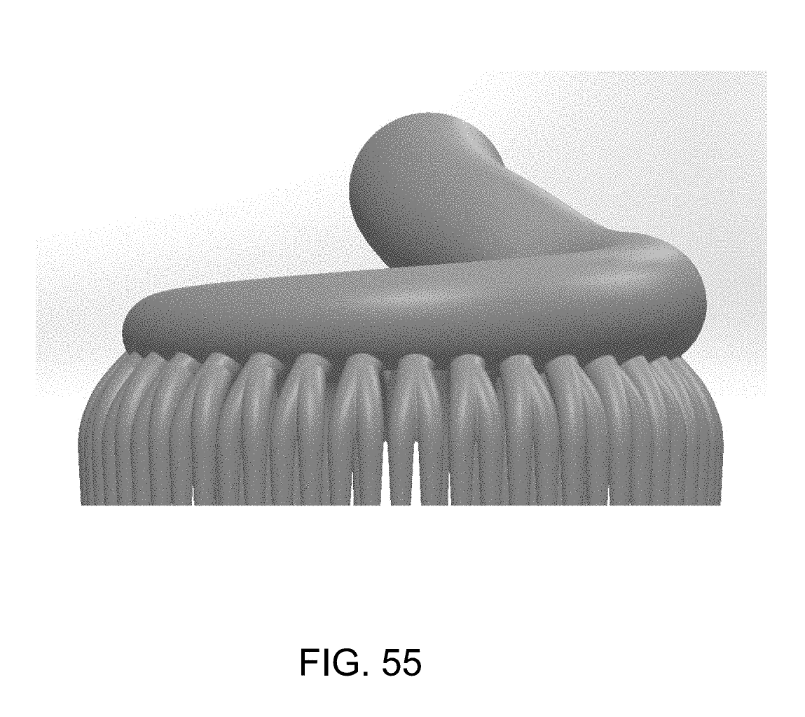

FIG. 52 shows a top-down view of the example fluid diverter employed in the liquid oxidizer fluid passages design. FIG. 53 shows a bottom-up view of the example fluid diverter employed in the liquid oxidizer fluid passages design. FIG. 54 shows one side view of a CAD rendering of the example fluid diverter employed in the liquid oxidizer fluid passages design. As shown, the main fluid passage is largest at the beginning, and becomes decreasingly smaller radially the farther along the fluid travels. It can be seen clearly here an example of how the fractal passages branch off from the main diverter channel. FIG. 55 shows an opposite side view of the CAD rendering from FIG. 54.

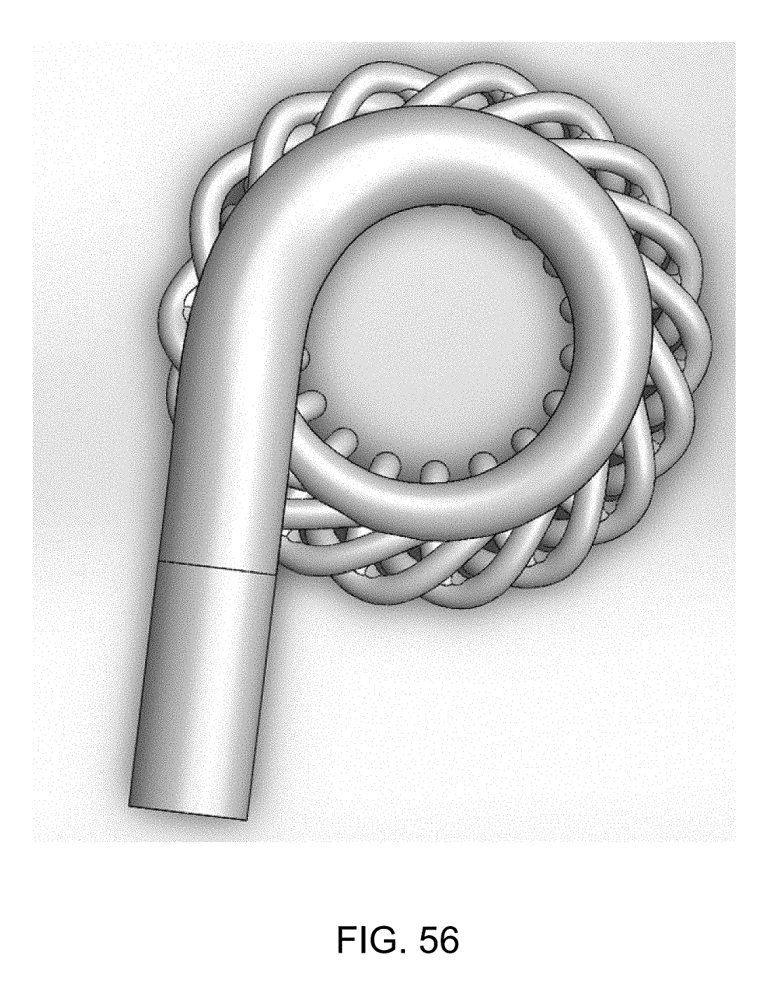

FIGS. 56-61 show another example of a decreasing annulus fluid diverter that may be employed to be included as part of the design for the fractal fluid passages leading to the injector orifices, according to some embodiments. In this case, each fluid passage from the decreasing annulus diverter leads to three injector orifices. This creates more asymmetry into the design, which increases stability and reduces the effects of pressure waves.

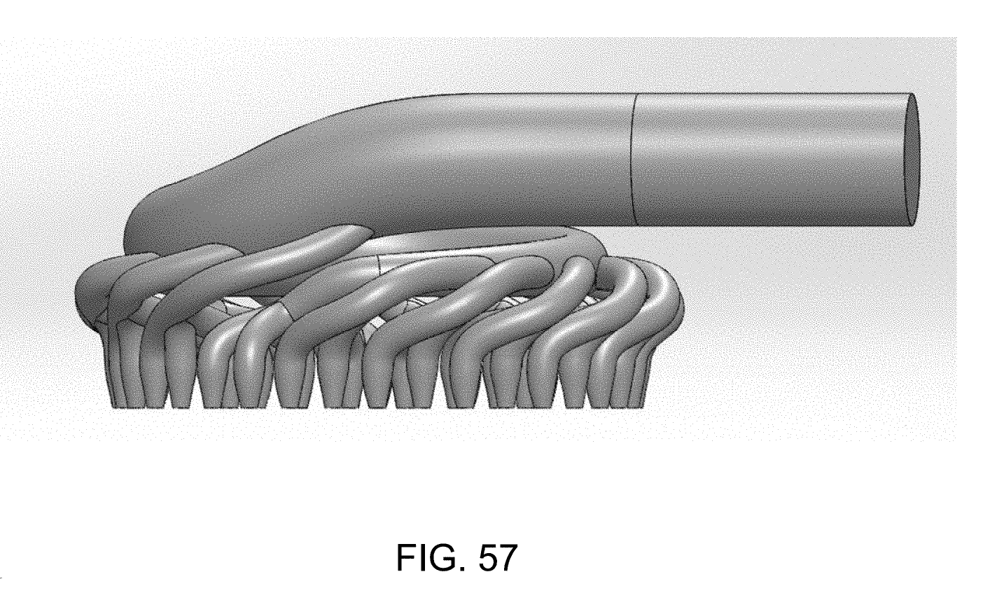

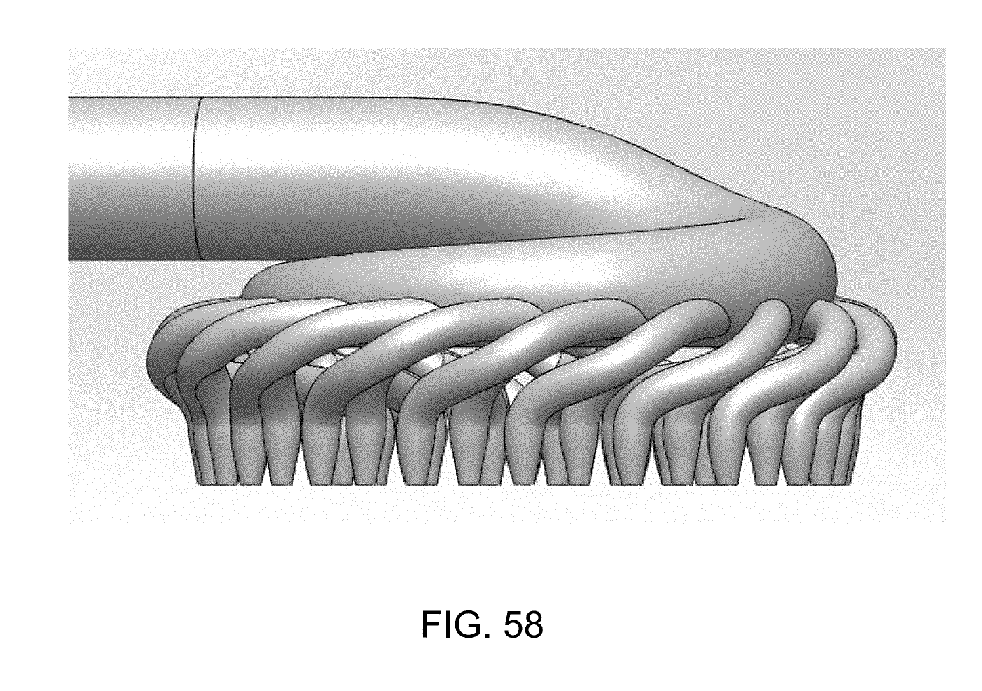

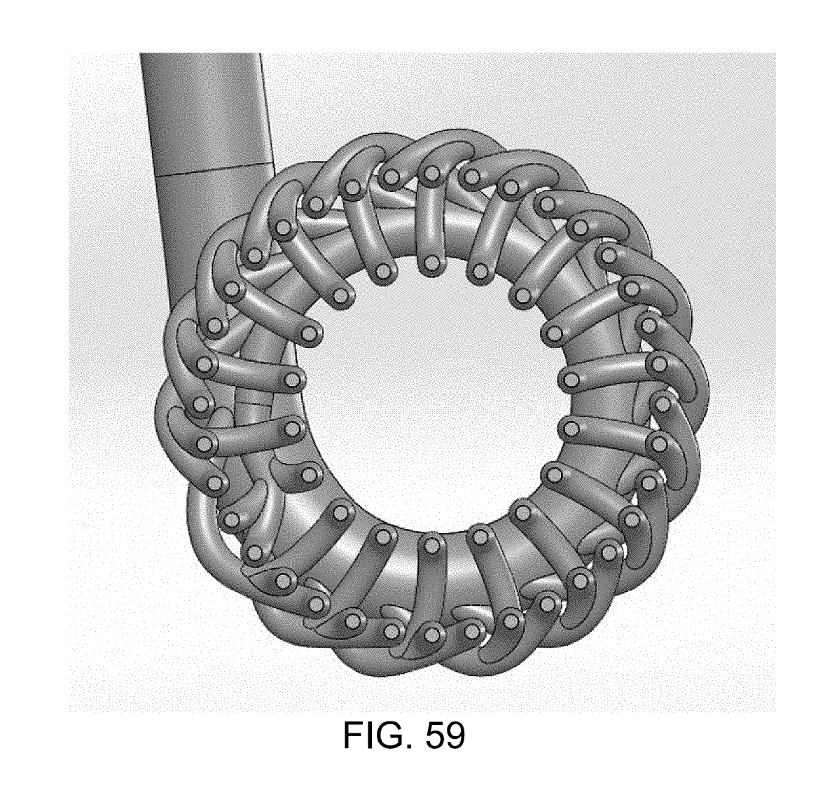

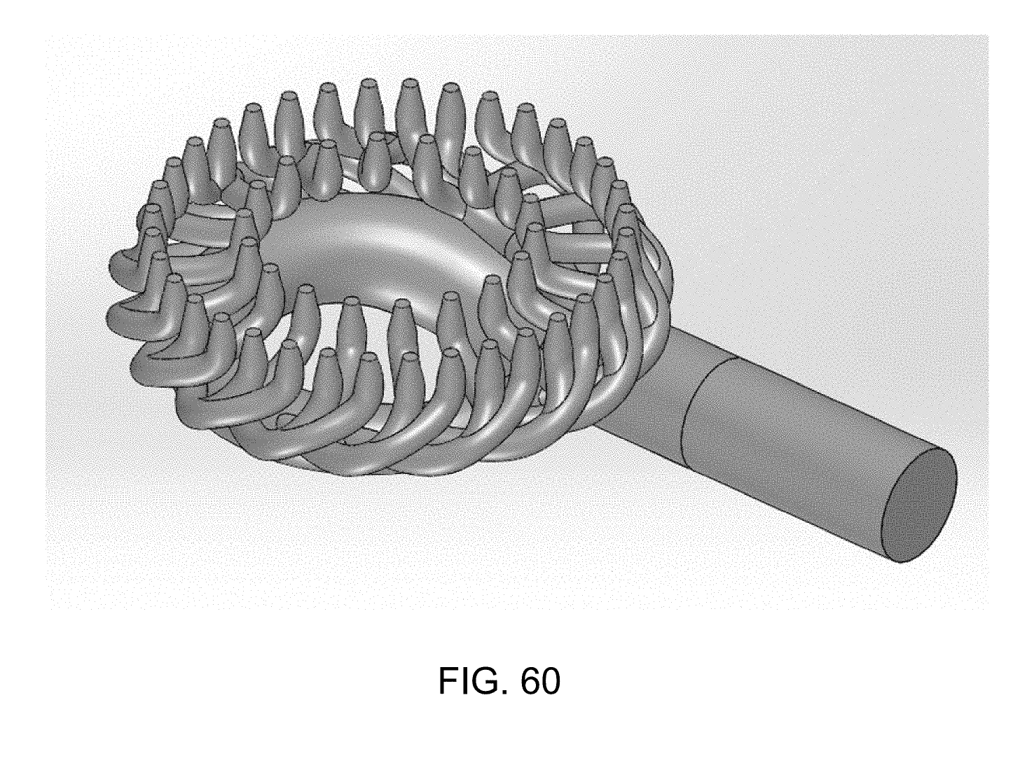

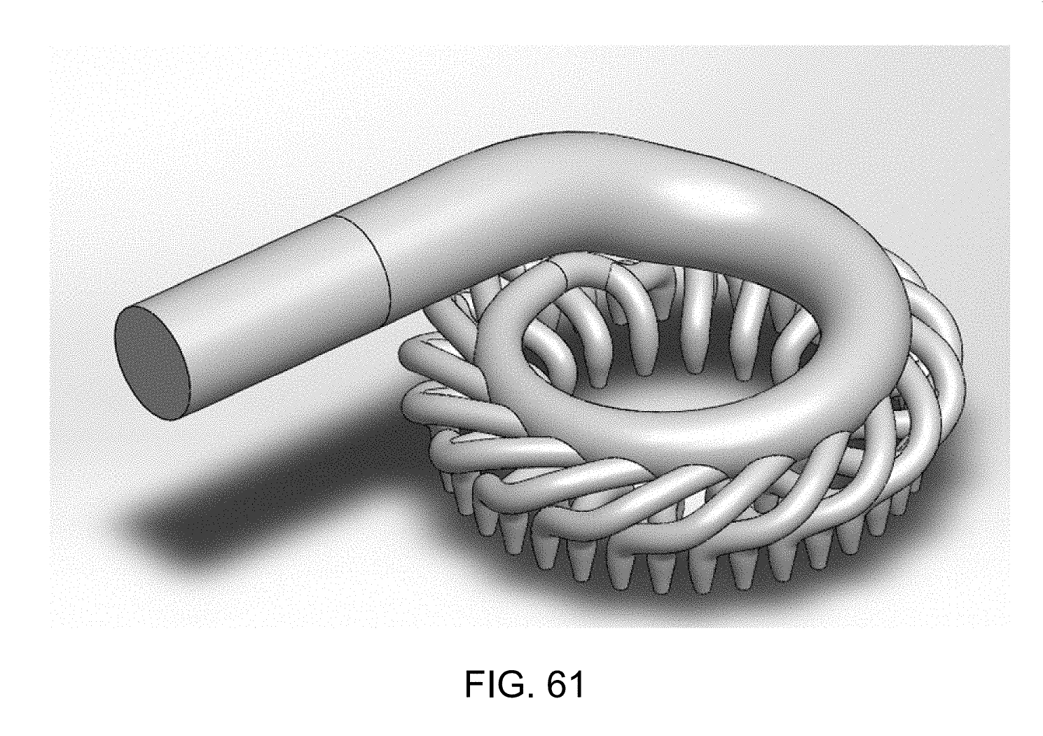

FIG. 56 shows a top-down view of this example fluid diverter. From here, it can be seen how the diverter decreases in radius over its length. FIG. 57 shows one side view of a CAD rendering of this example fluid diverter employed in the liquid oxidizer fluid passages design. As shown, the main fluid passage is largest at the beginning, and becomes decreasingly smaller radially the farther along the fluid travels. FIG. 58 shows an opposite side view of the CAD rendering from FIG. 57. FIG. 59 shows a bottom-up view of this example fluid diverter employed in the liquid oxidizer fluid passages design. From here, it can be seen how each passage from the diverter branches out into three injector orifices. FIG. 60 shows a perspective upside-down view of the diverter. FIG. 61 shows a top-down view of this example fluid diverter employed in the liquid oxidizer fluid passages design.

Embodiments Including Additional Features for Combustion Engine

The following are additional novel features surrounding the additively manufactured combustion engine.

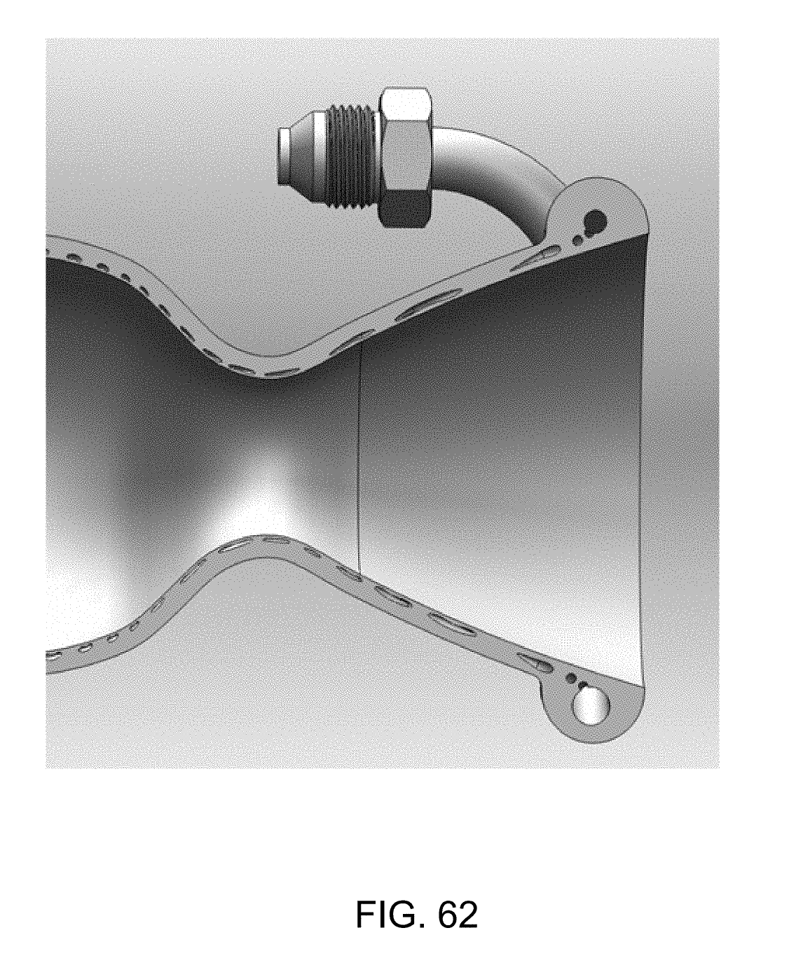

For example, FIG. 62 shows aspects of the nozzle that may be produced using additive manufacturing techniques. In some embodiments, the nozzle is a truncated ideal contour produced using an axisymmetric method of characteristics. The combustion chamber is a cylindrical cavity designed using the propellant characteristic length L*=1.1. This value is chosen based on historical data and prior experience. The contraction section, which begins at the end of the cylindrical portion of the combustion chamber, is constructed using a cubic polynomial. The total volume of the cylindrical portion and the contraction section sum to the volume required for complete combustion as calculated by the characteristic length. The diverging portion of the nozzle is truncated to 60% of the length of a 15 degree conical nozzle with the same exit area. Analysis has shown the presence of a near-wall shock which subsequently increases the near-wall pressure and increases the total thrust to nearly 450 lbf, a significant increase from the original design.

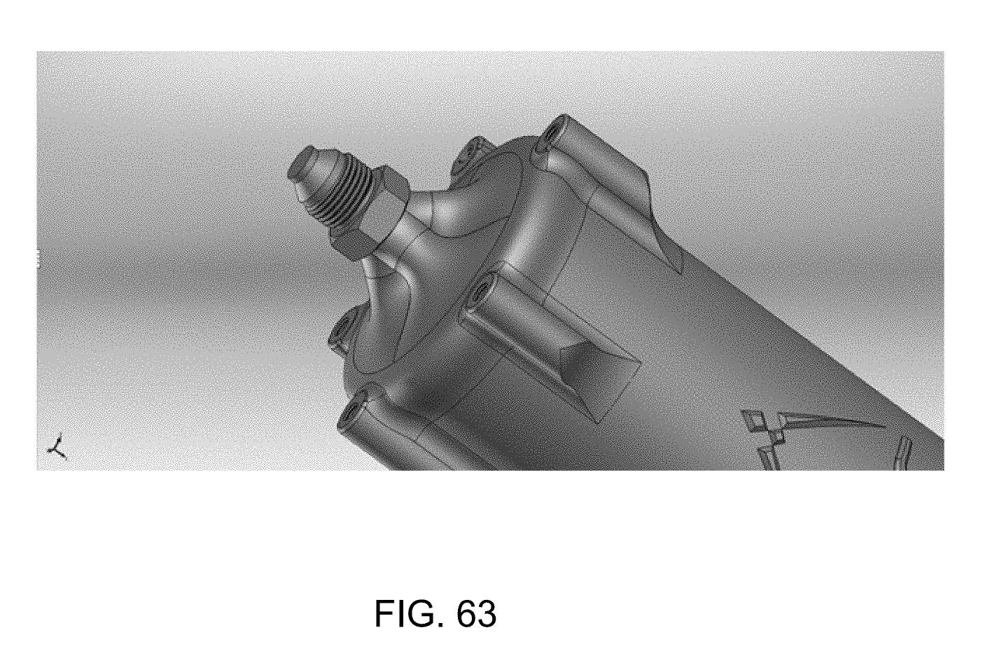

Referring to FIG. 63, shown is an illustration of a portion of the engine that is designed using shrink wrap techniques, according to some embodiments. In general, engineering design processes for critical components begin with assigning a factor of safety to the components. This value is used to determine the maximum allowable structural or thermal stress on the components. Typically, the region of the components under the highest stress is explicitly designed to have the prescribed factor of safety depending upon the failure mode. That region is then designed to have a “margin of safety” equal to zero. In the case of a rocket engine, this region is the throat. Here, the extreme structural and thermal loads place much stress on the surrounding material, making it prone to failure. Establishing a factor of safety at this location ensures that the component will not fail under the working conditions for which it was designed. This process typically results in a non-uniform margin of safety across the components. Since design parameters established for the critical region are employed in neighboring component regions under lower stress, neighboring regions have unnecessarily high margins of safety. As a result, there is an excess of material used to fortify these noncritical regions.

Shrink wrapping is the reduction in the outer profile of a component to fit more closely to the inner components. The shrink wrapping process creates components which uniformly achieve low margins of safety, thus producing a weight-optimized component. This method of designing components removes excess weight. External profiles of inner features are used to inform the boundaries of the outer shell. The pressure and temperature of the fluid contained within the internal features determines the minimum thickness of the wrapping. Metal material properties, unsteady flows and vibrations are all taken into account. After all parameters have been determined excess external material is removed from the model, reducing mass. These features are typically only producible through additive manufacturing.

In some embodiments, standard simulations performed on the fluid domain are used to determine the operating conditions by which the bounding material will be exposed to. External simulations may also be performed to determine the values of the following parameters and their distributions, which can be expected at each point of the structure surrounding and supporting the desired fluid. Critical parameters include: temperature, heat flux, pressure, corrosivity, vibration, abrasion, chemical reactions, along with thermal and structural loads and their distributions in space and time.

Depending on the operating conditions and parameters determined through simulation, experimentation, and testing, along with the properties of the desired structural material, an offset surface will be formed. The offset surface is a surface definition characterized by a distance from the fluid domain. The region of space between the outer surface of the fluid domain and the offset surface is considered the structural material jacket. The distance of the offset surface from the fluid domain is determined based on the thickness of the specified material necessary to obtain the desired margin of safety at the expected operating conditions. For complex fluid domains, additional smoothing, filleting and defeaturing may be necessary to reduce stress concentrations which may arise from the shape of the offset surface.

In addition, FIG. 63 features emphasis on the engine flange. The engine flange consists of several mounting holes extending radially outwards from the upper section of the chamber. The flanges are specifically optimized to support the mounting of the engine to a fixed support in the event of unsteady operation, transverse forcing, and typical steady, upward thrusting. Holes corresponding to required fastener arrangements are present in each of the flange arms. Similarly, threads for each of the bolts are printed into the holes, eliminating the need for nuts or other mounting components.

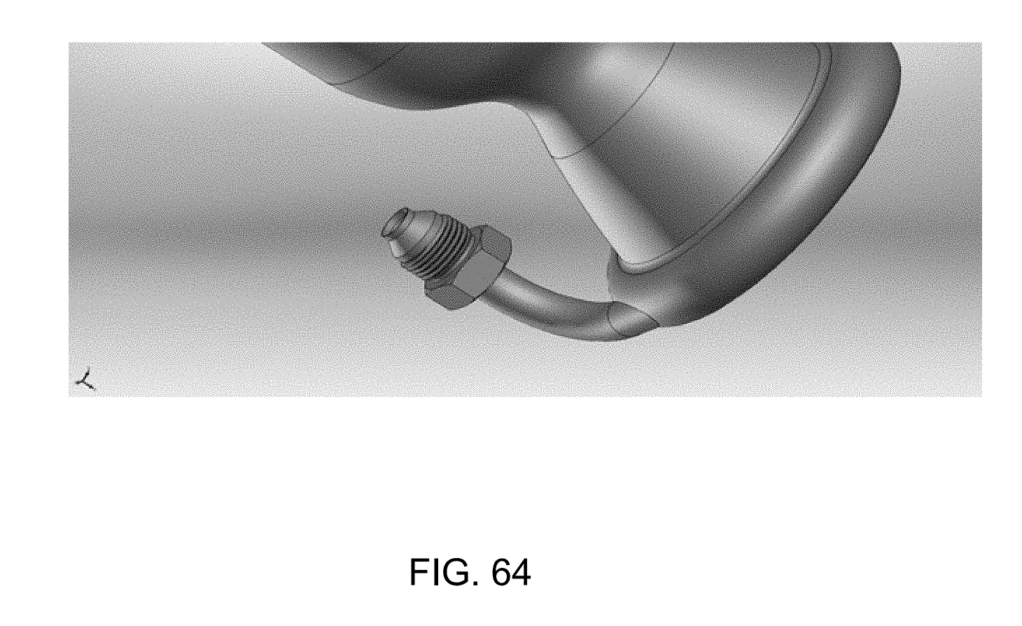

FIG. 64 shows an illustration emphasizing AN fittings for portions of the engine. AN fittings are printed onto the fuel and oxidizer inlets. These fittings include an attached nut, threads, and an angled surface for mating with the female AN fitting. The fitting geometry is a standard McMaster Carr AN8 fitting. The fitting was printed with support structure in contact with the upper lip. The critical angled surface must be as smooth as possible to avoid leaks and poor mating with the female fitting. To achieve this the AN fitting is printed so that the opening is oriented in the +z direction, reducing drooping, overhand, and roughness on the mating surface. The upward printing direction add uniformity to the surface roughness through the natural concentricity of perimeter layer surface roughness when produced using powder bed 3D printing methods such as Direct Metal Laswer Sintering (DMLS).

Embodiments of the present disclosure also include example techniques for producing any and all of the various components of the structural heat exchanger embodiments as described herein. In addition, embodiments also include any and all software or other computer-readable media used to program machines for manufacturing said components, and embodiments are not so limited.

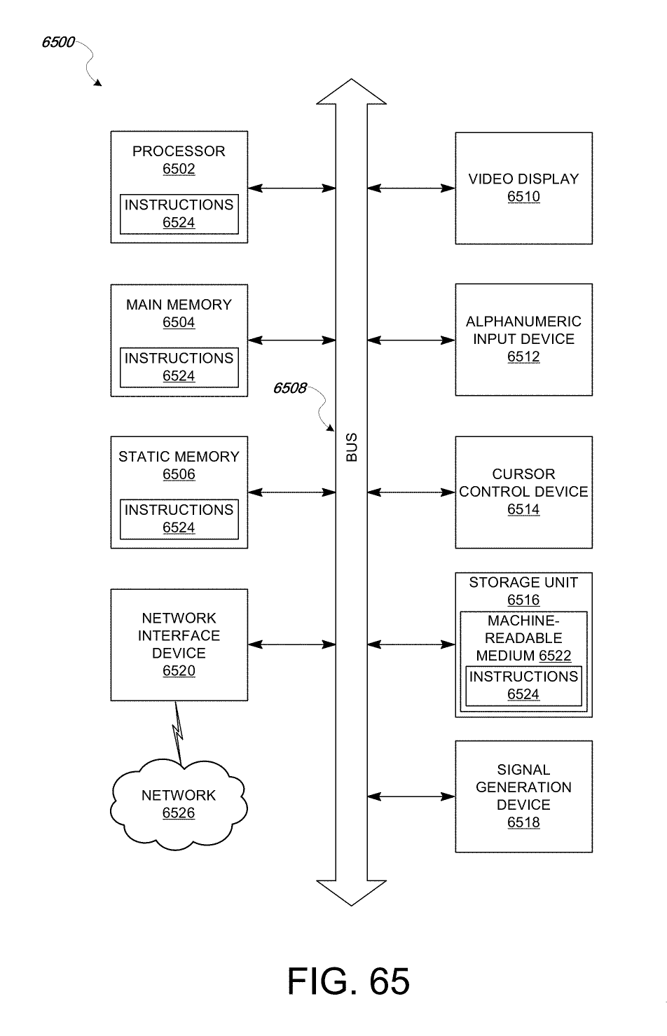

Referring to FIG. 65, the block diagram illustrates components of a machine 6500, according to some example embodiments, able to read instructions 6524 from a machine-readable medium 6522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 65 shows the machine 6500 in the example form of a computer system (e.g., a computer) within which the instructions 6524 (e.g., software, a program, an application, an applet, an app, or other executable code) for causing the machine 6500 to perform any one or more of the methodologies discussed herein may be executed, in whole or in part.

In alternative embodiments, the machine 6500 operates as a standalone device or may be connected (e.g., networked) to other machines. In a networked deployment, the machine 6500 may operate in the capacity of a server machine or a client machine in a server-client network environment, or as a peer machine in a distributed (e.g., peer-to-peer) network environment. The machine 6500 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 6524, sequentially or otherwise, that specify actions to be taken by that machine. Further, while only a single machine 6500 is illustrated, the term “machine” shall also be taken to include any collection of machines that individually or jointly execute the instructions 6524 to perform all or part of any one or more of the methodologies discussed herein.

The machine 6500 includes a processor 6502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 6504, and a static memory 6506, which are configured to communicate with each other via a bus 6508. The processor 6502 may contain microcircuits that are configurable, temporarily or permanently, by some or all of the instructions 6524 such that the processor 6502 is configurable to perform any one or more of the methodologies described herein, in whole or in part. For example, a set of one or more microcircuits of the processor 6502 may be configurable to execute one or more modules (e.g., software modules) described herein.

The machine 6500 may further include a video display 6510 (e.g., a plasma display panel (PDP), a light emitting diode (LED) display, a liquid crystal display (LCD), a projector, a cathode ray tube (CRT), or any other display capable of displaying graphics or video). The machine 6500 may also include an alphanumeric input device 6512 (e.g., a keyboard or keypad), a cursor control device 6514 (e.g., a mouse, a touchpad, a trackball, a joystick, a motion sensor, an eye tracking device, or other pointing instrument), a storage unit 6516, a signal generation device 6518 (e.g., a sound card, an amplifier, a speaker, a headphone jack, or any suitable combination thereof), and a network interface device 6520.

The storage unit 6516 includes the machine-readable medium 6522 (e.g., a tangible and non-transitory machine-readable storage medium) on which are stored the instructions 6524 embodying any one or more of the methodologies or functions described herein, including, for example, any of the descriptions of FIGS. 1-64. The instructions 6524 may also reside, completely or at least partially, within the main memory 6504, within the processor 6502 (e.g., within the processor's cache memory), or both, before or during execution thereof by the machine 6500. The instructions 6524 may also reside in the static memory 6506.

Accordingly, the main memory 6504 and the processor 6502 may be considered machine-readable media 6522 (e.g., tangible and non-transitory machine-readable media). The instructions 6524 may be transmitted or received over a network 6526 via the network interface device 6520. For example, the network interface device 6520 may communicate the instructions 6524 using any one or more transfer protocols (e.g., HTTP). The machine 6500 may also represent example means for performing any of the functions described herein, including the processes described in FIGS. 1-64.

In some example embodiments, the machine 6500 may be a portable computing device, such as a smartphone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 6522 able to store data temporarily or permanently and may be taken to include, but not be limited to, random-access memory (RAM), read-only memory (ROM), buffer memory, flash memory, and cache memory. While the machine-readable medium 6522 is shown in an example embodiment to be a single medium, the term “machine-readable medium” should be taken to include a single medium or multiple media (e.g., a centralized or distributed database, or associated caches and servers) able to store instructions 6524. The term “machine-readable medium” shall also be taken to include any medium, or combination of multiple media, that is capable of storing the instructions 6524 for execution by the machine 6500, such that the instructions 6524, when executed by one or more processors of the machine 6500 (e.g., processor 6502), cause the machine 6500 to perform any one or more of the methodologies described herein, in whole or in part. Accordingly, a “machine-readable medium” refers to a single storage apparatus or device, as well as cloud-based storage systems or storage networks that include multiple storage apparatuses or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 6522 is non-transitory in that it does not embody a propagating signal. However, labeling the tangible machine-readable medium 6522 as “non-transitory” should not be construed to mean that the medium is incapable of movement; the medium should be considered as being transportable from one physical location to another. Additionally, since the machine-readable medium 6522 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 6522 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 6502 or a group of processors 6502) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 6502 or other programmable processor 6502. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 6508) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 6502 that are temporarily configured (e.g., by software) or permanently configured to perform the relevant operations. Whether temporarily or permanently configured, such processors 6502 may constitute processor-implemented modules that operate to perform one or more operations or functions described herein. As used herein, “processor-implemented module” refers to a hardware module implemented using one or more processors 6502.

Similarly, the methods described herein may be at least partially processor-implemented, a processor 6502 being an example of hardware. For example, at least some of the operations of a method may be performed by one or more processors 6502 or processor-implemented modules. As used herein, “processor-implemented module” refers to a hardware module in which the hardware includes one or more processors 6502. Moreover, the one or more processors 6502 may also operate to support performance of the relevant operations in a “cloud computing” environment or as a “software as a service” (SaaS). For example, at least some of the operations may be performed by a group of computers (as examples of machines 6500 including processors 6502), with these operations being accessible via a network 6526 (e.g., the Internet) and via one or more appropriate interfaces (e.g., an API).

The performance of certain operations may be distributed among the one or more processors 6502, not only residing within a single machine 6500, but deployed across a number of machines 6500. In some example embodiments, the one or more processors 6502 or processor-implemented modules may be located in a single geographic location (e.g., within a home environment, an office environment, or a server farm). In other example embodiments, the one or more processors 6502 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 6500 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A combustion engine comprising:
a heat exchanger comprising a plurality of coolant channels, the heat exchanger configured to divert heat through a wall at least partially enclosing a region containing a high heat volume relative to surrounding volumes;
a fluid diverter coupled to the plurality of channels in the heat exchanger; and
a fractal fluid passages oxidizer;
wherein the combustion engine is manufactured using additive manufacturing.

2. The combustion engine of claim 1, wherein each of the plurality of coolant channels has at least a portion of cross-sectional area in a shape of a bean.

3. The combustion engine of claim 1, wherein each of the plurality of coolant channels has at least a portion of cross-sectional area in a shape of a trapezoid with rounded corners.

4. The combustion engine of claim 1, wherein each of the plurality of coolant channels has at least a portion of cross-sectional area in a shape defined by satisfying a plurality of boundary conditions defining one or more functional or structural properties of the wall.

5. The combustion engine of claim 4, wherein the plurality of boundary conditions include:
at least one thermal condition that the wall must satisfy;
at least one structural condition that the wall must satisfy;
at least one material property about the wall that the wall must satisfy; and
at least one material property of the coolant channels that the plurality of coolant channels must satisfy.

6. The combustion engine of claim 4, wherein:
the plurality of boundary conditions is a first plurality of boundary conditions applied to a first location of the coolant channels, and
each of the plurality of coolant channels has at least a portion of cross-sectional area at a second location in a second shape defined by satisfying a second plurality of boundary conditions that are different than the first plurality of boundary conditions.

8. The combustion engine of claim 1, wherein the plurality of coolant channels vary in pitch angle at different locations within the wall.

9. The combustion engine of claim 1, wherein at least one of the plurality of coolant channels includes a first cross-sectional area at a first location shaped in a first shape, and a second cross-sectional area at a second location shaped in a second shape.

10. The combustion engine of claim 9, wherein the first shape is a bean shape, and the second shape is an ellipse shape.

11. The combustion engine of claim 1, wherein the plurality of coolant channels vary in size of cross-sectional area at different locations within the wall.

12. The combustion engine of claim 1, further comprising an engine flange having threads that are additively manufactured as a single piece along with the engine flange.

13. The combustion engine of claim 1, wherein exterior material of the combustion engine is minimized using a shrink-wrapping additive manufacturing process.

14. The combustion engine of claim 1, wherein the fluid diverter comprises a uniformly decreasing radius annulus.

15. The combustion engine of claim 1, wherein the fractal fluid passages oxidizer comprises smooth branching passages.

16. The combustion engine of claim 1, wherein the fractal fluid passages oxidizer comprises a first portion and second portion of fluid orifices to allow fluid to exit the oxidizer, wherein the first portion of the orifices allow the fluid to exit the oxidizer at a different angle compared to the second portion of the orifices.

17. The combustion engine of claim 1, further comprising a fractal fluid passages fuel injector.

18. The combustion engine of claim 17, wherein the fractal fluid passages fuel injector comprises smooth branching passages.

19. The combustion engine of claim 1, wherein the engine is manufactured as a single piece using additive manufacturing.
